(19) United States
(12) Patent Application Publication
(10) Pub. No.: US 2014/0009574 A1
(43) Pub. Date: Jan. 9, 2014

(54) APPARATUS, A METHOD AND A COMPUTER PROGRAM FOR VIDEO CODING AND DECODING

(71) Applicant: NOKIA CORPORATION, Espoo (FI)

(72) Inventors: Miska Matias Hannuksela, Tampere (FI); Lulu Chen, Anhui (CN)

(73) Assignee: NOKIA CORPORATION, Espoo (FI)

(21) Appl. No.: 13/744,090

(22) Filed: Jan. 17, 2013

Related U.S. Application Data
(60) Provisional application No. 61/588,600, filed on Jan. 19, 2012.

(51) Int. Cl. H04N 7/32

(52) U.S. Cl. CPC H04N 19/00769
USPC 348/42

(57) ABSTRACT

There is disclosed a method in which depth related information of a part of a picture is obtained and texture related information of the part of the picture is received. The depth related information is used to determine whether to use the depth related information in intra prediction of the texture related information of the part of the picture. There is also disclosed an apparatus and a computer program product to implement the method.

### TECHNICAL FIELD

The present invention relates to an apparatus, a method and a computer program for video coding and decoding.

### BACKGROUND INFORMATION

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

Several technologies for view rendering are available, and for example, depth image-based rendering (DIBR) has shown to be a competitive alternative. A typical implementation of DIBR takes stereoscopic video and corresponding depth information with stereoscopic baseline as input and synthesizes a number of virtual views between the two input views. Thus, DIBR algorithms may also enable extrapolation of views that are outside the two input views and not in between them. Similarly, DIBR algorithms may enable view synthesis from a single view of texture and the respective depth view.

In the encoding of 3D video content, video compression systems, such as Advanced Video Coding standard H.264/AVC or the Multiview Video Coding MVC extension of H.264/AVC can be used. However, the intra prediction for specified in H.264/AVC/MVC may not be optimal for video coding systems utilizing depth or disparity information.

### SUMMARY

This invention proceeds from the consideration that the depth or disparity information (Di) for a current block (cb) of texture data is available through decoding of coded depth or disparity information or can be estimated at the decoder side prior to decoding of the current texture block, thus making it possible to utilize this information in intra prediction. For example, in DIBR-based systems, multiview rendering at the decoder side is enabled by providing texture data at the decoder side along with the corresponding depth or disparity information (Di). The utilization of depth or disparity information (Di) in intra prediction may improve compression in multi-view, multi-view+depth, and MVC-VSP coding systems.

Many embodiments of the invention are based on detection of blocks which have a depth boundary and specific handling of those blocks. It is assumed in many embodiments that a sample value should be used for texture intra prediction only if it resides in the same object, i.e. in the same depth range, as the sample being predicted.

In some embodiments depth information is utilized for intra prediction of texture. The depth information may be used to predict or determine picture partitioning and coding order; block partitioning and coding order; intra prediction mode; and prediction sample availability and weight for intra prediction. In addition, the multi-directional intra prediction may be used based on the depth information.

According to a first aspect of the invention, there is provided a method comprising:

obtaining depth related information of a part of a picture;

receiving texture related information of the part of the picture;

using the depth related information to determine whether to use the depth related information in intra prediction of the texture related information of the part of the picture.

According to a second aspect of the invention, there is provided an apparatus comprising

at least one processor and at least one memory including computer program code, the at least one memory and the computer program code configured to, with the at least one processor, cause the apparatus to:

obtain depth related information of a part of a picture;

receive texture related information of the part of the picture;

use the depth related information to determine whether to use the depth related information in intra prediction of the texture related information of the part of the picture.

According to a third aspect of the invention, there is provided a computer

program product including one or more sequences of one or more instructions which, when executed by one or more processors, cause an apparatus to at least perform the following:

obtain depth related information of a part of a picture;

receive texture related information of the part of the picture;

use the depth related information to determine whether to use the depth related information in intra prediction of the texture related information of the part of the picture.

According to a fourth aspect of the invention there is provided an apparatus comprising:

means for obtaining depth related information of a part of a picture;

means for receiving texture related information of the part of the picture;

means for using the depth related information to determine whether to use the depth related information in ultra prediction of the texture related information of the part of the picture.

According to a fifth aspect of the invention, there is provided a method comprising:

receiving encoded depth related information of a part of a picture;

receiving encoded texture related information of the part of the picture;

using the depth related information in decoding the texture related information to determine whether to use the depth related information in intra prediction of the texture related information of the part of the picture.

According to a sixth aspect of the invention, there is provided an apparatus comprising at least one processor and at least one memory including computer program code, the at least one memory and the computer program code configured to, with the at least one processor, cause the apparatus to:

receive encoded depth related information of a part of a picture;

receive encoded texture related information of the part of the picture;

use the depth related information in decoding to determine whether to use the depth related information in intra prediction of the texture related information of the part of the picture.

According to a seventh aspect of the invention, there is provided a computer program product including one or more sequences of one or more instructions which, when executed by one or more processors, cause an apparatus to at least perform the following:

receive encoded depth related information of a part of a picture;

receive encoded texture related information of the part of the picture;

use the depth related information in decoding to determine whether to use the depth related information in intra prediction of the texture related information of the part of the picture.

According to an eight aspect of the invention, there is provided an apparatus comprising:

means for receiving encoded depth related information of a part of a picture;

means for receiving encoded texture related information of the part of the picture;

means for using the depth related information in decoding to determine whether to use the depth related information in intra prediction of the texture related information of the part of the picture.

According to a ninth aspect of the invention, there is provided a video coder configured for:

obtaining depth related information of a part of a picture;

receiving texture related information of the part of the picture;

using the depth related information to determine whether to use the depth related information in intra prediction of the texture related information of the part of the picture.

According to a tenth aspect of the invention, there is provided a video decoder configured for:

receiving encoded depth related information of a part of a picture;

receiving encoded texture related information of the part of the picture;

using the depth related information in decoding the texture related information to determine whether to use the depth related information in intra prediction of the texture related information of the part of the picture.

### DESCRIPTION OF THE DRAWINGS

For better understanding of the present invention, reference will now be made by way of example to the accompanying drawings in which:

FIG. 1 shows a simplified 2D model of a stereoscopic camera setup;

FIG. 2 shows a simplified model of a multiview camera setup;

FIG. 3 shows a simplified model of a multiview autostereoscopic display (ASD);

FIG. 4 shows a simplified model of a DIBR-based 3DV system;

FIGS. 5 and 6 show an example of a TOF-based depth estimation system;

FIG. 7 shows spatial neighborhood of the currently coded block serving as the candidates for intra prediction in H.264/AVC;

FIG. 8 shows an example of labelling of prediction samples of a block of a picture;

FIGS. 9a to 9i show some examples of intra prediction modes;

FIG. 10 shows schematically an electronic device suitable for employing some embodiments of the invention;

FIG. 11 shows schematically a user equipment suitable for employing some embodiments of the invention;

FIG. 12 further shows schematically electronic devices employing embodiments of the invention connected using wireless and wired network connections;

FIG. 13 shows an example of a Wedgelet partition of a block;

FIG. 14 shows an example of definition and coding order of access units;

FIG. 15 illustrates an example of a gradient calculation on a 4×4 block of pixels;

FIG. 16 shows an example of mapping of a depth map into another view;

FIG. 17 shows an example of generation of an initial depth map estimate after coding a first dependent view of a random access unit;

FIG. 18 shows an example of derivation of a depth map estimate for the current picture using motion parameters of an already coded view of the same access unit;

FIG. 19 shows an example of updating of a depth map estimate for a dependent view based on coded motion and disparity vectors;

FIG. 20 shows a high level flow chart of an embodiment of an encoder capable of encoding texture views and depth views;

FIG. 21 shows a high level flow chart of an embodiment of a decoder capable of decoding texture views and depth views; and

FIG. 22 shows intra prediction mode directions available in an example embodiment.

### DETAILED DESCRIPTION OF SOME EXAMPLE EMBODIMENTS OF THE INVENTION

In order to understand the various aspects of the invention and the embodiments related thereto, the following describes briefly some closely related aspects of video coding.

Some key definitions, bitstream and coding structures, and concepts of H.264/AVC are described in this section as an example of a video encoder, decoder, encoding method, decoding method, and a bitstream structure, wherein the embodiments may be implemented. The aspects of the invention are not limited to H.264/AVC, but rather the description is given for one possible basis on top of which the invention may be partly or fully realized.

The H.264/AVC standard was developed by the Joint Video Team (JVT) of the Video Coding Experts Group (VCEG) of the Telecommunications Standardisation Sector of International Telecommunication Union (ITU-T) and the Moving Picture Experts Group (MPEG) of International Standardisation Organisation (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

Similarly to many earlier video coding standards, the bitstream syntax and semantics as well as the decoding process for error-free bitstreams are specified in H.264/AVC. The encoding process is not specified, but encoders must generate conforming bitstreams. Bitstream and decoder conformance can be verified with the Hypothetical Reference Decoder (HRD), which is specified in Annex C of H.264/AVC. The standard contains coding tools that help in coping with transmission errors and losses, but the use of the tools in encoding is optional and no decoding process has been specified for erroneous bitstreams.

The elementary unit for the input to an H.264/AVC encoder and the output of an H.264/AVC decoder is a picture. A picture may either be a frame or a field. A frame typically comprises a matrix of luma samples and corresponding chroma samples. A field is a set of alternate sample rows of a frame and may be used as encoder input, when the source signal is interlaced. A macroblock is a 16×16 block of luma samples and the corresponding blocks of chroma samples. A block has boundary samples, which consist of the samples at the top-most and bottom-most rows of samples and at the left-most and right-most columns of samples. Boundary samples adjacent to another block being coded or decoded may be used for example in intra prediction. Chroma pictures may be subsampled when compared to luma pictures. For example, in the 4:2:0 sampling pattern the spatial resolution of chroma pictures is half of that of the luma picture along both coordinate axes and consequently a macroblock contains one 8×8 block of chroma samples per each chroma component. A picture is partitioned to one or more slice groups, and a slice group contains one or more slices. A slice consists of an integer number of macroblocks ordered consecutively in the raster scan within a particular slice group.

The elementary unit for the output of an H.264/AVC encoder and the input of an H.264/AVC decoder is a Network Abstraction Layer (NAL) unit. Decoding of partially lost or corrupted NAL units is typically difficult. For transport over packet-oriented networks or storage into structured files, NAL units are typically encapsulated into packets or similar structures. A bytestream format has been specified in H.264/AVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention is performed always regardless of whether the bytestream format is in use or not.

H.264/AVC, as many other video coding standards, allows splitting of a coded picture into slices. In-picture prediction is disabled across slice boundaries. Thus, slices can be regarded as a way to split a coded picture into independently decodable pieces, and slices are therefore elementary units for transmission.

Some profiles of H.264/AVC enable the use of up to eight slice groups per coded picture. When more than one slice group is in use, the picture is partitioned into slice group map units, which are equal to two vertically consecutive macroblocks when the macroblock-adaptive frame-field (MBAFF) coding is in use and equal to a macroblock otherwise. The picture parameter set contains data based on which each slice group map unit of a picture is associated with a particular slice group. A slice group can contain any slice group map units, including non-adjacent map units. When more than one slice group is specified for a picture, the flexible macroblock ordering (FMO) feature of the standard is used.

In H.264/AVC, a slice consists of one or more consecutive macroblocks (or macroblock pairs, when MBAFF is in use) within a particular slice group in raster scan order. If only one slice group is in use, H.264/AVC slices contain consecutive macroblocks in raster scan order and are therefore similar to the slices in many previous coding standards. In some profiles of H.264/AVC slices of a coded picture may appear in any order relative to each other in the bitstream, which is referred to as the arbitrary slice ordering (ASO) feature. Otherwise, slices must be in raster scan order in the bitstream.

NAL units consist of a header and payload. The NAL unit header indicates the type of the NAL unit and whether a coded slice contained in the NAL unit is a part of a reference picture or a non-reference picture. The header for SVC and MVC NAL units additionally contains various indications related to the scalability and multiview hierarchy.

NAL units can be categorized into Video Coding Layer (VCL) NAL units and non-VCL NAL units. VCL NAL units are either coded slice NAL units, coded slice data partition NAL units, or VCL prefix NAL units. Coded slice NAL units contain syntax elements representing one or more coded macroblocks, each of which corresponds to a block of samples in the uncompressed picture. There are four types of coded slice NAL units: coded slice in an Instantaneous Decoding Refresh (IDR) picture, coded slice in a non-IDR picture, coded slice of an auxiliary coded picture (such as an alpha plane) and coded slice extension (for SVC slices not in the base layer or MVC slices not in the base view). A set of three coded slice data partition NAL units contains the same syntax elements as a coded slice. Coded slice data partition A comprises macroblock headers and motion vectors of a slice, while coded slice data partition B and C include the coded residual data for intra macroblocks and inter macroblocks, respectively. It is noted that the support for slice data partitions is only included in some profiles of H.264/AVC. A VCL prefix NAL unit precedes a coded slice of the base layer in SVC and MVC bitstreams and contains indications of the scalability hierarchy of the associated coded slice.

A non-VCL NAL unit may be of one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets are essential for the reconstruction of decoded pictures, whereas the other non-VCL NAL units are not necessary for the reconstruction of decoded sample values and serve other purposes presented below.

Many parameters that remain unchanged through a coded video sequence are included in a sequence parameter set. In addition to the parameters that are essential to the decoding process, the sequence parameter set may optionally contain video usability information (VUI), which includes parameters that are important for buffering, picture output timing, rendering, and resource reservation. A picture parameter set contains such parameters that are likely to be unchanged in several coded pictures. No picture header is present in H.264/AVC bitstreams but the frequently changing picture-level data is repeated in each slice header and picture parameter sets carry the remaining picture-level parameters. H.264/AVC syntax allows many instances of sequence and picture parameter sets, and each instance is identified with a unique identifier. Each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets using a more reliable transmission mechanism compared to the protocols used for the slice data. For example, parameter sets can be included as a parameter in the session description for H.264/AVC Real-time Transport Protocol (RTP) sessions. If parameter sets are transmitted in-band, they can be repeated to improve error robustness.

A SEI NAL unit contains one or more SEI messages, which are not required for the decoding of output pictures but assist in related processes, such as picture output timing, rendering, error detection, error concealment, and resource reservation. Several SEI messages are specified in H.264/AVC, and the user data SEI messages enable organizations and companies to specify SEI messages for their own use. H.264/AVC contains the syntax and semantics for the specified SEI messages but no process for handling the messages in the recipient is defined. Consequently, encoders are required to follow the H.264/AVC standard when they create SEI messages, and decoders conforming to the H.264/AVC standard are not required to process SEI messages for output order conformance. One of the reasons to include the syntax and semantics of SEI messages in H.264/AVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture in H.264/AVC consists of the VCL NAL units that are required for the decoding of the picture. A coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded.

In H.264/AVC, an access unit consists of a primary coded picture and those NAL units that are associated with it. The appearance order of NAL units within an access unit is constrained as follows. An optional access unit delimiter NAL unit may indicate the start of an access unit. It is followed by zero or more SEI NAL units. The coded slices or slice data partitions of the primary coded picture appear next, followed by coded slices for zero or more redundant coded pictures.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit always results in one decoded picture consisting of one or more decoded view components. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. A closed GOP is such a group of pictures in which all pictures can be correctly decoded when the decoding starts from the initial intra picture of the closed GOP. In other words, no picture in a closed GOP refers to any pictures in previous GOPs. In H.264/AVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC indicates whether a particular picture is a reference picture for inter prediction of any other picture. Pictures of any coding type (I, P, B) can be reference pictures or non-reference pictures in H.264/AVC. The NAL unit header indicates the type of the NAL unit and whether a coded slice contained in the NAL unit is a part of a reference picture or a non-reference picture.

There is an ongoing video coding standardization project for specifying a High Efficiency Video Coding (HEVC) standard. Many of the key definitions, bitstream and coding structures, and concepts of HEVC are the same as or similar to those of H.264/AVC. Some key definitions, bitstream and coding structures, and concepts of HEVC are described in this section as an example of a video encoder, decoder, encoding method, decoding method, and a bitstream structure, wherein the embodiments may be implemented. The aspects of the invention are not limited to HEVC, but rather the description is given for one possible basis on top of which the invention may be partly or fully realized.

In a Working Draft (WD) of HEVC, some key definitions and concepts for picture partitioning are defined as follows. A partitioning is defined as the division of a set into subsets such that each element of the set is in exactly one of the subsets.

A basic coding unit in a HEVC WD is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

Many hybrid video codecs, including H.264/AVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may be also referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

A texture view refers to a view that represents ordinary video content, for example has been captured using an ordinary camera, and is usually suitable for rendering on a display. A texture view typically comprises pictures having three components, one luma component and two chroma components. In the following, a texture picture typically comprises all its component pictures or color components unless otherwise indicated for example with terms luma texture picture and chroma texture picture.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

Depth-enhanced video may be coded in a manner where texture and depth are coded independently of each other. For example, texture views may be coded as one MVC bitstream and depth views may be coded as another MVC bitstream. Alternatively depth-enhanced video may be coded in a manner where texture and depth are jointly coded. When joint coding texture and depth views is applied for a depth-enhanced video representation, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture.

Many video encoders utilize the Lagrangian cost function to find rate-distortion optimal coding modes, for example the desired macroblock mode and associated motion vectors. This type of cost function uses a weighting factor or λ to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

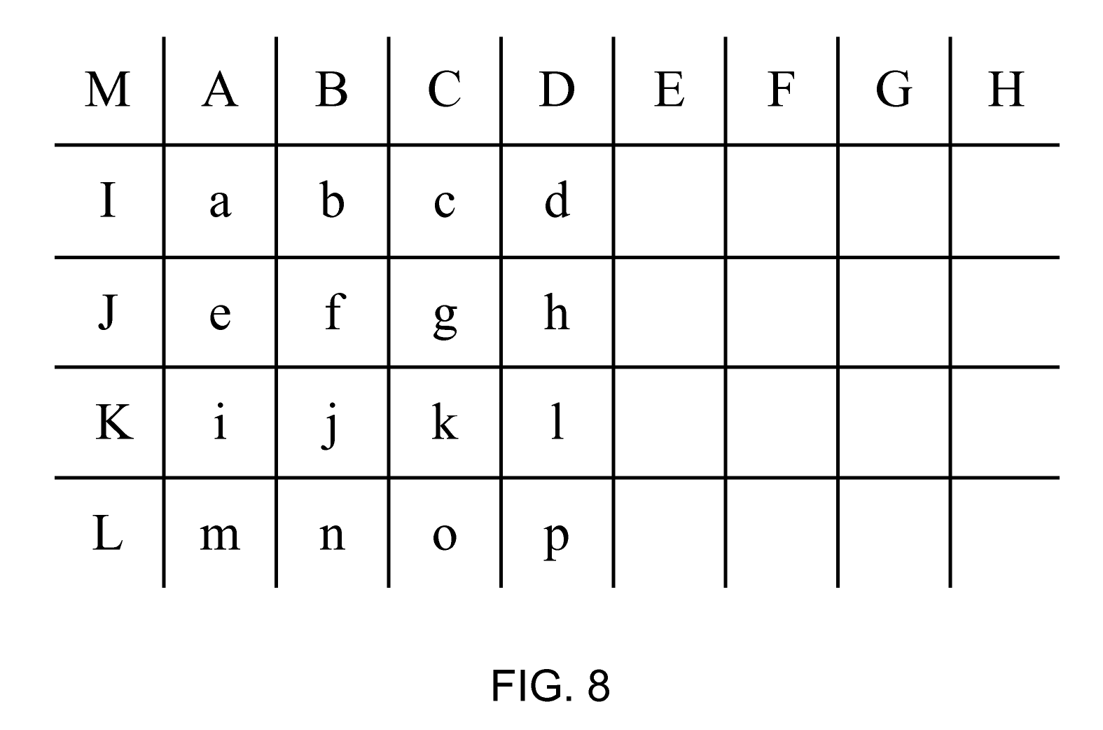

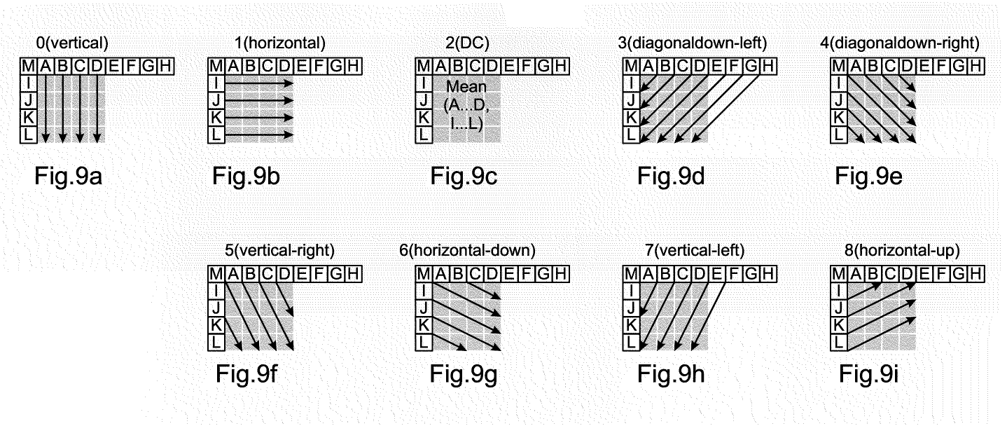

In intra prediction another part in the same picture or frame than the block to be encoded/decoded is used as a reference for intra prediction. The reference may be, for example, another block or a part of another block in the same picture or frame. An example of 4×4 intra prediction is taken with reference to FIG. 8, where luma sample values a to p are predicted from the luma sample values A to M of the neighboring blocks, where samples A to M are located as shown in FIGS. 9a to 9i. FIG. 9a depicts a vertical intra prediction mode (mode 0), FIG. 9b depicts a horizontal intra prediction mode (mode 1), FIG. 9c depicts a DC intra prediction mode (mode 2) where essentially an average of the prediction samples is used for intra prediction, FIG. 9d depicts a diagonal down-left intra prediction mode (mode 3), FIG. 9e depicts a diagonal down-right intra prediction mode (mode 4), FIG. 9f depicts a vertical-right intra prediction mode (mode 5), FIG. 9g depicts a horizontal-down intra prediction mode (mode 6), FIG. 9h depicts a vertical-left intra prediction mode (mode 7), and FIG. 9i depicts a horizontal-up intra prediction mode (mode 8).

In H.264/AVC, each one of the samples A to M is “available for intra prediction” or “not available for intra prediction” depending on e.g. whether constrained intra prediction is turned on or off, whether the samples were intra-coded, and whether the samples resided in the same slice as the current block.

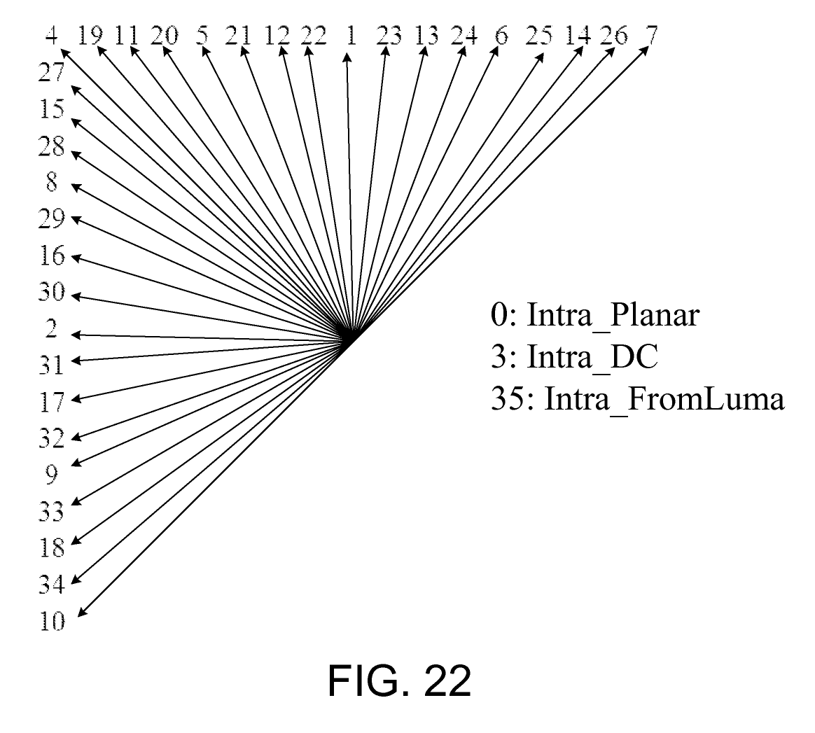

Different embodiments are not limited to be used in combination with the intra prediction modes available in H.264/AVC. For example, different embodiments may be used with intra prediction mode directions available in a HEVC WD, with reference to FIG. 22.

The Multiview Video Coding (MVC) extension of H.264 referred above enables to implement a multiview functionality at the decoder, thereby allowing the development of three-dimensional (3D) multiview applications. Next, for better understanding the embodiments of the invention, some aspects of 3D multiview applications and the concepts of depth and disparity information closely related thereto are described briefly.

Stereoscopic video content consists of pairs of offset images that are shown separately to the left and right eye of the viewer. These offset images are captured with a specific stereoscopic camera setup and it assumes a particular stereo baseline distance between cameras.

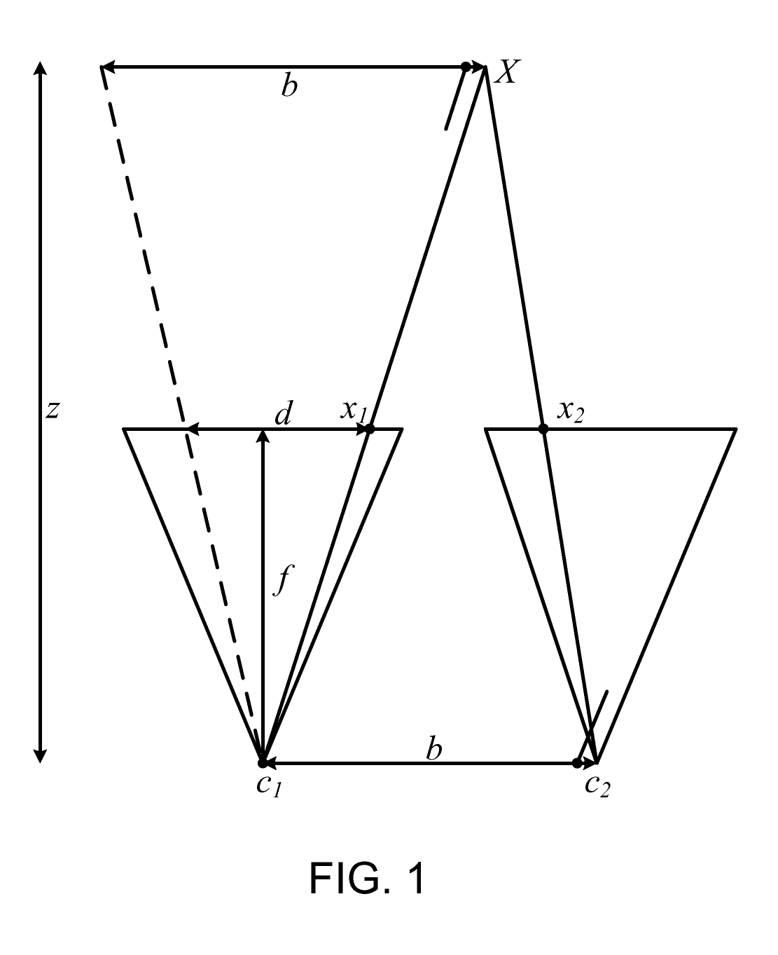

FIG. 1 shows a simplified 2D model of such stereoscopic camera setup. In FIG. 1, C1 and C2 refer to cameras of the stereoscopic camera setup, more particularly to the center locations of the cameras, b is the distance between the centers of the two cameras (i.e. the stereo baseline), f is the focal length of the cameras and X is an object in the real 3D scene that is being captured. The real world object X is projected to different locations in images captured by the cameras C1 and C2, these locations being x1 and x2 respectively. The horizontal distance between x1 and x2 in absolute coordinates of the image is called disparity. The images that are captured by the camera setup are called stereoscopic images, and the disparity presented in these images creates or enhances the illusion of depth. For enabling the images to be shown separately to the left and right eye of the viewer, specific 3D glasses may be required to be used by the viewer. Adaptation of the disparity is a key feature for adjusting the stereoscopic video content to be comfortably viewable on various displays.

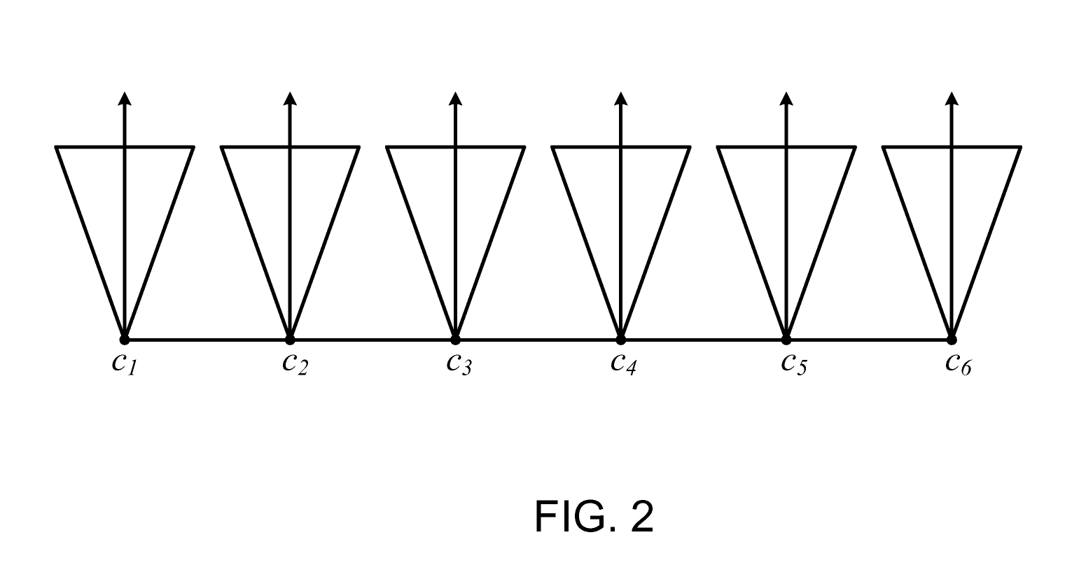

However, disparity adaptation is not a straightforward process. It requires either having additional camera views with different baseline distance (i.e., b is variable) or rendering of virtual camera views which were not available in real world. FIG. 2 shows a simplified model of such multiview camera setup that suits to this solution. This setup is able to provide stereoscopic video content captured with several discrete values for stereoscopic baseline and thus allow stereoscopic display to select a pair of cameras that suits to the viewing conditions.

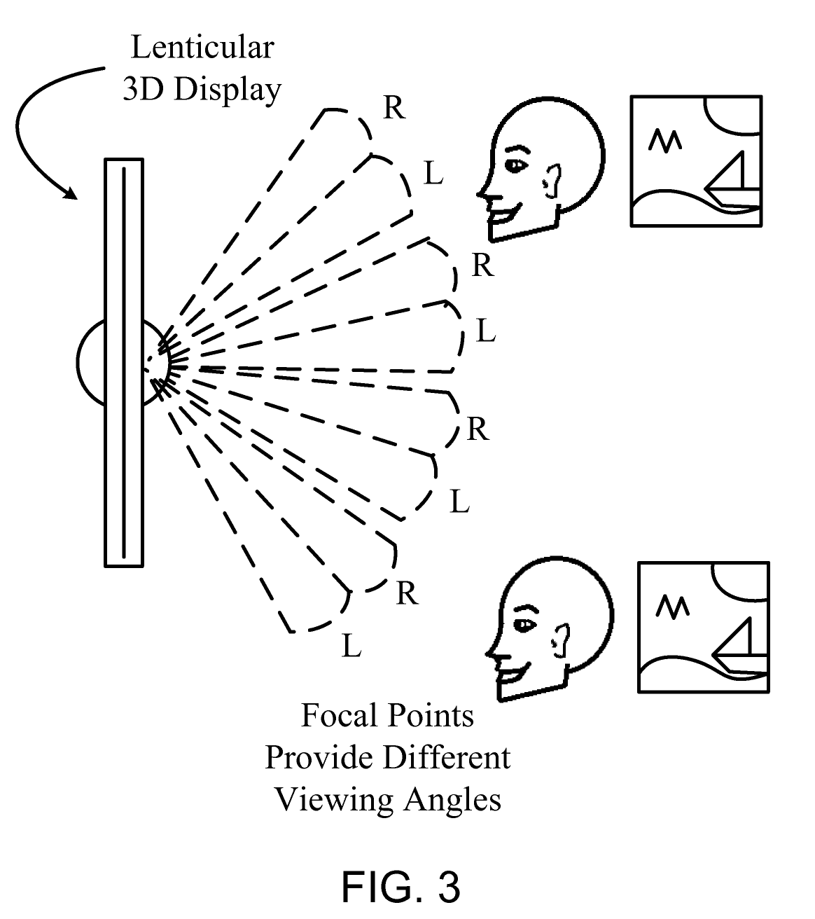

A more advanced approach for 3D vision is having a multiview autostereoscopic display (ASD) that does not require glasses. The ASD emits more than one view at a time but the emitting is localized in the space in such a way that a viewer sees only a stereo pair from a specific viewpoint, as illustrated in FIG. 3, wherein the boat is seen in the middle of the view when looked at the right-most viewpoint. Moreover, the viewer is able see another stereo pair from a different viewpoint, e.g. in FIG. 3 the boat is seen at the right border of the view when looked at the left-most viewpoint. Thus, motion parallax viewing is supported if consecutive views are stereo pairs and they are arranged properly. The ASD technologies may be capable of showing for example 52 or more different images at the same time, of which only a stereo pair is visible from a specific viewpoint. This supports multiuser 3D vision without glasses, for example in a living room environment.

The above-described stereoscopic and ASD applications require multiview video to be available at the display. The MVC extension of H.264/AVC video coding standard allows the multiview functionality at the decoder side. The base view of MVC bitstreams can be decoded by any H.264/AVC decoder, which facilitates introduction of stereoscopic and multiview content into existing services. MVC allows inter-view prediction, which can result into significant bitrate saving compared to independent coding of all views, depending on how correlated the adjacent views are. However, the rate of MVC coded video is proportional to the number of views. Considering that ASD may require 52 views, for example, as input, the total bitrate for such number of views will challenge the constraints of the available bandwidth.

Consequently, it has been found that a more feasible solution for such multiview application is to have a limited number of input views, e.g. a mono or a stereo view plus some supplementary data, and to render (i.e. synthesize) all required views locally at the decoder side. From several available technologies for view rendering, depth image-based rendering (DIBR) has shown to be a competitive alternative.

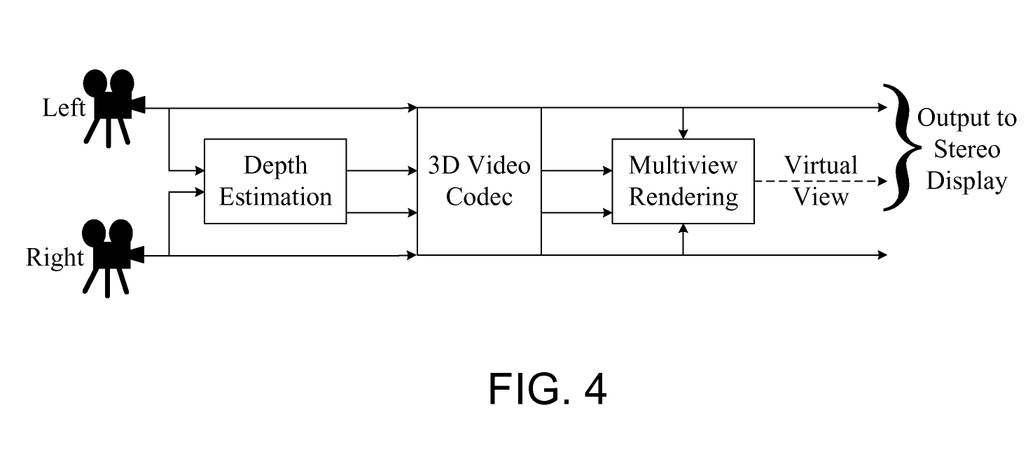

A simplified model of a DIBR-based 3DV system is shown in FIG. 4. The input of a 3D video codec comprises a stereoscopic video and corresponding depth information with stereoscopic baseline b0. Then the 3D video codec synthesizes a number of virtual views between two input views with baseline (bi<b0). DIBR algorithms may also enable extrapolation of views that are outside the two input views and not in between them. Similarly, DIBR algorithms may enable view synthesis from a single view of texture and the respective depth view. However, in order to enable DIBR-based multiview rendering, texture data should be available at the decoder side along with the corresponding depth data.

In such 3DV system, depth information is produced at the encoder side in a form of depth pictures (also known as depth maps) for each video frame. A depth map is an image with per-pixel depth information. Each sample in a depth map represents the distance of the respective texture sample from the plane on which the camera lies. In other words, if the z axis is along the shooting axis of the cameras (and hence orthogonal to the plane on which the cameras lie), a sample in a depth map represents the value on the z axis.

Depth information can be obtained by various means. For example, depth of the 3D scene may be computed from the disparity registered by capturing cameras. A depth estimation algorithm takes a stereoscopic view as an input and computes local disparities between the two offset images of the view. Each image is processed pixel by pixel in overlapping blocks, and for each block of pixels a horizontally localized search for a matching block in the offset image is performed. Once a pixel-wise disparity is computed, the corresponding depth value z is calculated by equation (1):

$$z = \frac{f \cdot b}{d + Δ d} , \qquad ( 1 )$$

where f is the focal length of the camera and b is the baseline distance between cameras, as shown in FIG. 1. Further, d refers to the disparity observed between the two cameras, and the camera offset Δd reflects a possible horizontal misplacement of the optical centers of the two cameras. However, since the algorithm is based on block matching, the quality of a depth-through-disparity estimation is content dependent and very often not accurate. For example, no straightforward solution for depth estimation is possible for image fragments that are featuring very smooth areas with no textures or large level of noise.

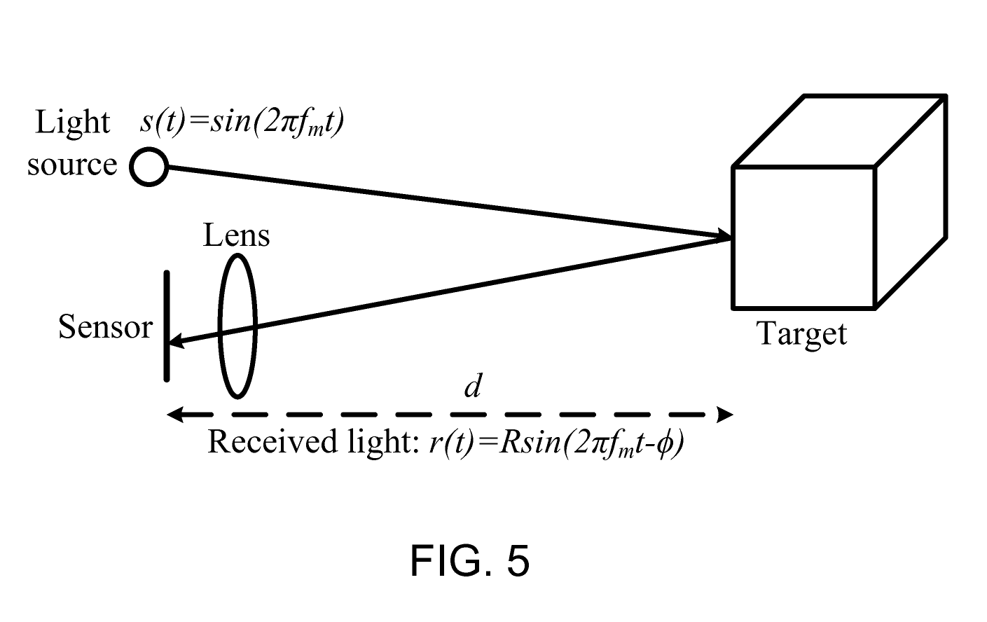

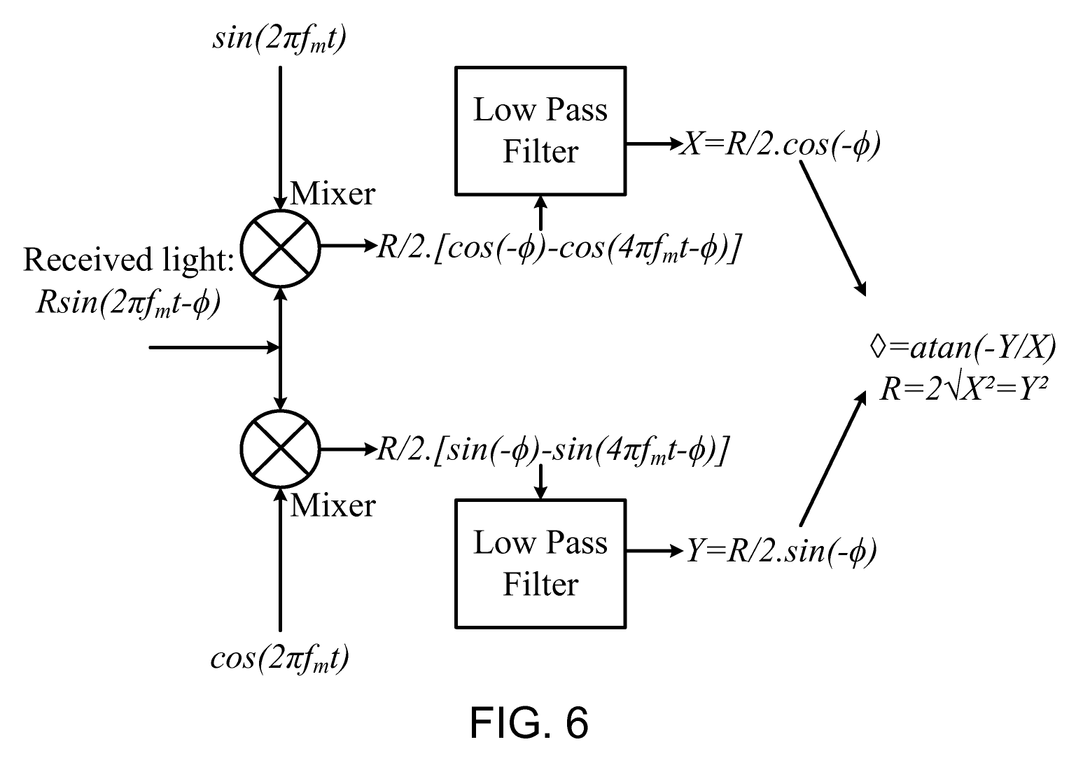

Alternatively, or in addition to the above-described stereo view depth estimation, the depth value may be obtained using the time-of-flight (TOF) principle. FIGS. 5 and 6 show an example of a TOF-based depth estimation system. The camera is provided with a light source, for example an infrared emitter, for illuminating the scene. Such an illuminator may be arranged to produce an intensity modulated electromagnetic emission for a frequency between e.g. 10-100 MHz, which may require LEDs or laser diodes to be used. Infrared light is typically used to make the illumination unobtrusive. The light reflected from objects in the scene is detected by an image sensor, which is modulated synchronously at the same frequency as the illuminator. The image sensor is provided with optics; a lens gathering the reflected light and an optical bandpass filter for passing only the light with the same wavelength as the illuminator, thus helping to suppress background light. The image sensor measures for each pixel the time the light has taken to travel from the illuminator to the object and back. The distance to the object is represented as a phase shift in the illumination modulation, which can be determined from the sampled data simultaneously for each pixel in the scene.

In contrast to the stereo view depth estimation, the accuracy of the TOF-based depth estimation is mostly content independent. For example, it is not suffering from the lack of textural appearance in the content. However, currently available TOF cameras have low pixel resolution sensors and the depth estimation is heavily influenced by random and systematic noise.

Disparity or parallax maps, such as parallax maps specified in ISO/IEC International Standard 23002-3, may be processed similarly to depth maps. Depth and disparity have a straightforward correspondence and they can be computed from each other through mathematical equation.

Now in order to improve intra prediction for the purposes of multi-view coding (MVC), depth-enhanced video coding, multiview+depth (MVD) coding and multi-view with in-loop view synthesis (MVC-VSP), a set of new intra prediction mechanisms based on utilization of the depth or disparity information (Di) for a current block (cb) of texture data are provided herein.

It is assumed that the depth or disparity information (Di) for a current block (cb) of texture data is available through decoding of coded depth or disparity information or can be estimated at the decoder side prior to decoding of the current texture block, and this information can be utilized in intra prediction.

In the following, a texture block typically refers to a block of samples of a single color component of a texture picture, i.e. typically a block of samples of one of the luma or chroma components of a texture picture.

The encoder according to some example embodiments of the present invention may include one or more of the following operations for coding of intra-coded texture blocks. It should be noted here that similar principles are also applicable at a decoder side for decoding of intra-coded texture blocks. While many of example embodiments are described with reference to depth, it is to be understood that the example embodiments could use disparity or parallax in place of depth. Many of the example embodiments are described with reference to term block, which may be for example a macroblock similar to that used in H.264/AVC, a treeblock similar to that used in a HEVC WD, or anything alike.

### Depth Boundary Detection

The encoder may apply depth boundary detection e.g. as follows. A depth boundary may also be referred to as a depth edge, a depth discontinuity, or a depth contour, for example. In the encoder, an associated (reconstructed/decoded) depth block is classified to either contain a depth boundary or not. In some embodiments, the same depth boundary detection algorithm is performed also in the decoder, and then both the encoder and decoder perform the depth boundary detection for reconstructed/decoded depth pictures. The detected depth boundaries may be used in one or more of the operations described below.

The encoder and the decoder may try to detect possible edges or other boundaries within a picture or a block e.g. by using an edge or boundary detection algorithm. There may be many possible algorithms which may be applied. For example, the depth boundary classification may be done as follows. The classification may use a Sobel operator using the following two 3×3 kernels to obtain a gradient magnitude image G:

$${G}_{x} = [ \begin{matrix}- 1 & 0 & + 1 \\ - 2 & 0 & + 2 \\ - 1 & 0 & + 1\end{matrix} ] * A and$$

$${G}_{y} = [ \begin{matrix}- 1 & - 2 & - 1 \\ 0 & 0 & 0 \\ + 1 & + 2 & + 1\end{matrix} ] * A$$

$$G = \sqrt{{G}_{x}^{2} + {G}_{y}^{2}}$$

where A is the source image (the reconstructed depth image).

As sequences may have different dynamic sample value ranges in G value, G may be converted to image G′ using histogram equalization. In the histogram equalization, the min and max values of G′ may be set to 0 and 255, respectively. Further, a first threshold T1 and a second threshold T2 may also be set to appropriate values. The encoder or the decoder may examine if G′(x, y)>T1. If so, the point (x, y) is classified to the boundary points. When the histogram equalization has been performed for the current block, the number of possible boundary points in the current block may be checked to determine, if the number of boundary points in one block is larger than the second threshold T2. If so, this block is classified to contain a depth boundary.

In some embodiments, the encoder may determine the value of any of the above-mentioned thresholds T1 and T2 for example based on encoding blocks with different values of the threshold and selecting the value of the threshold that is optimal according to the Lagrangian rate-distortion optimization equation. The encoder may indicate the determined values of the thresholds T1 and/or T2 within the bitstream, for example by encoding them as one or more syntax elements for example in a sequence parameter set, a picture parameter set, a slice parameter set, a picture header, a slice header, within a macroblock syntax structure, or anything alike. In some embodiments, the decoder determines the thresholds T1 and/or T2 based on the information encoded in the bistream, such as one or more codewords indicating the value of thresholds T1 and/or T2.

A texture block contains, covers, includes, has, or is with a depth boundary when the depth block co-located with the texture block contains a depth boundary. In some embodiments, depth is coded at a different spatial resolution than texture. Therefore, scaling according to the proportion of the spatial resolutions may be taken into account in the determination when a texture block contains or covers a depth boundary.

### Depth-Based Picture Partitioning

The encoder may partition a picture on the basis of depth information. In some embodiments the encoder codes the picture partitioning into the bitstream, while in other embodiments the decoder partitions a picture on the basis of depth information. The encoder and decoder may change the block coding or decoding order according to the picture partitioning so that blocks of one picture partition may precede in coding or decoding order blocks of another picture partition.

In some embodiments, the block coding order and respectively the decoding order may be changed so that texture blocks not containing a depth boundary are coded or decoded first e.g. in a raster-scan order while texture blocks including a depth boundary are skipped and coded or decoded subsequently. Texture blocks containing a depth boundary may be marked in encoding and/or decoding as not available for prediction for the blocks not containing a depth boundary (as if they were in a different slice and constrained intra prediction turned on).

In some embodiments, the block coding order and respectively the decoding order may be changed so that texture blocks including a depth boundary are coded or decoded first e.g. in raster scan order, while texture blocks not containing a depth boundary are coded or decoded subsequently to the texture blocks including a depth boundary e.g. in a raster-scan order. Texture blocks not containing a depth boundary may be marked in encoding and/or decoding as not available for prediction for the blocks containing a depth boundary (as if they were in a different slice and constrained intra prediction turned on).

In the depth-based picture partitioning, the encoder may in some embodiments use slice_group_map_type 6 of flexible macroblock ordering of H.264/AVC, which enables to provide a macroblock-wise mapping from macroblocks to slice groups. The creation of the slice group map may be performed based on the classified depth edge macroblocks, i.e. all the macroblocks classified as not containing a depth edge belong to one slice group, and the macroblocks with a depth edge belong to another slice group.

In some other embodiments, the encoder and decoder infer the slice group mapping based on the depth boundary classification of reconstructed/decoded depth view components. For example, all the macroblocks classified as not containing a depth edge belong to one slice group, and the macroblocks with a depth edge belong to another slice group.

In another example, all macroblocks of the same depth range may be classified in encoding and/or decoding to form a slice group while the macroblocks containing a depth edge may be classified in encoding and/or decoding to form their own slice group.

The slice group containing macroblocks classified to include a depth boundary may be coded or decoded after the other slice group(s). Alternatively, the slice group containing macroblocks classified to include a depth boundary may be coded or decoded before the other slice group(s).

In some embodiments, the macroblocks are coded or decoded in raster-scan order or any other pre-defined order otherwise but the macroblocks containing a depth edge are skipped and coded or decoded after all other macroblocks of the same slice. Alternatively, the macroblocks containing a depth edge are coded or decoded before all other macroblocks of the same slice.

### Depth-Based Block Partitioning

The encoder may partition a texture block on the basis of depth information. In some embodiments, the encoder performs block partitioning so that one set of block partitions contains a depth boundary while another set of block partitions does not contain any depth boundary. The encoder may select the block partitions using a defined criterion or defined criteria; for example, the encoder may select the size of blocks not containing a depth boundary to be as large as possible. In some embodiments, the decoder also runs the same block partitioning algorithm, while in other embodiments the encoder signals the used block partitioning to the decoder e.g. using conventional H.264/AVC block partitioning syntax element(s).

In some embodiments, e.g. embodiments for H.264/AVC, intra-coded luma texture macroblocks can be partitioned in 16×16, 8×8, or 4×4 blocks for intra prediction, but it is obvious that also other block sizes may be applied. Furthermore, the blocks need not be squared blocks but other formats are also applicable. As a generalization, the block size may be represented as M×N in which M,NεZ₊.

In some embodiments, the block partitioning of the depth block is used as the block partitioning for the respective or co-located texture block.

In some embodiments no block partitioning is coded or indicated in the bitstream. Therefore, the encoder and decoder may perform the same depth-based block partitioning.

When information on the block partitioning is delivered from the encoder to the decoder, there may be many options for that. For example, the information on the block partitioning may be entropy coded to a bitstream. Entropy coding of the block partitioning may be performed in many ways. For example, the encoder signals the used block partitioning to the decoder e.g. using a H.264/AVC block partitioning syntax element(s). In some embodiments, the block partitioning is coded into the bitstream but the depth-based block partitioning is applied in both encoder and decoder to modify the context state of a context adaptive binary arithmetic coding (CABAC) or context-based variable length coding or any similar entropy coding in such a manner that the block partitioning chosen by the depth-based block partitioning method uses smaller amount of coded data bits. In effect, the likelihood of the block partitioning deduced by the depth-based block partitioning derivation is increased in the entropy coding and decoding.

In some embodiments, the block partitioning is coded into the bitstream but the code table or binarization table used in the block partitioning codeword may be dependent on the result of the depth-based block partitioning.

The used block partitioning method may be selected by the encoder e.g. through rate-distortion optimization and may be indicated by the encoder as a syntax element or elements or a value of a syntax element in the coded bitstream. The syntax element(s) may reside for example in the sequence parameter set, picture parameter set, adaptation parameter set, picture header, or slice header.

The encoder may, for example, perform conventional block partitioning selection e.g. using a rate-distortion optimization. If the rate-distortion cost of conventional block partitioning is smaller than that of the depth-based bock partitioning, the encoder may choose to use a conventional block partitioning and indicate the use of the conventional block partitioning in the bitstream for example in the slice header, macroblock syntax, or block syntax.

The decoder may decode the syntax element(s) related to the block partitioning method and decode the bitstream using the indicated block partitioning methods and related syntax elements.

The coding or decoding order of sub-blocks or block partitions within a block may be determined based on the depth boundary or boundaries. For example, in H.264/AVC based coding or decoding, the coding order of blocks according to the block partitioning within a macroblock may be determined based on the depth boundaries. The blocks without a depth boundary may be coded or decoded prior to the blocks having a depth boundary.

For example, for coding or decoding a texture macroblock containing a depth boundary in a H.264/AVC based coding/decoding scheme, the 8×8 blocks not containing a depth boundary (if any) may be coded or decoded first. Following that, the 4×4 blocks not containing a depth boundary (which reside in those 8×8 blocks that contain depth boundaries) may be coded or decoded. Finally, the 4×4 blocks containing a depth boundary may be coded or decoded using for example a bi-directional intra prediction mode.

In another example for an H.264/AVC based coding/decoding scheme, the 4×4 texture blocks containing a depth boundary are coded or decoded first. Then, the remaining samples of the texture macroblock are predicted from the boundary samples of the neighboring texture macroblocks and the reconstructed/decoded 4×4 texture blocks including a depth boundary.

Block partitioning is conventionally performed using a regular grid of sub-block positions. For example, in H.264/AVC, the macroblock may be partitioned to 4×4 or larger blocks at a regular 4×4 grid within the macroblock. In some embodiments, block partitioning of texture blocks is applied in a manner that at least one of the coordinates of a sub-block position differs from a regular grid of sub-block positions. In these embodiments, sub-blocks having a depth boundary may for example be selected in a manner that their vertical coordinate follows the regular 4×4 grid but that their horizontal coordinate is chosen for example to minimize the number of 4×4 sub-blocks having a depth boundary.

In some embodiments, the block partitioning used for intra prediction of a texture block may differ from the block partitioning used for prediction error coding or decoding of the same texture block. For example, any of the methods above based on the detection of a depth boundary may be used for determining the block partitioning for intra prediction of a texture block, and a different block partitioning may be used for transform-coded prediction error coding or decoding. The encoder and/or the decoder may infer the block partitioning used for intra prediction of the texture based on the co-located or respective depth reconstructed or decoded depth. The encoder may encode into the bitstream the block partitioning for prediction error coding of the intra-coded texture block, and the decoder may decode the block partitioning used for prediction error decoding of the intra-coded texture block from the bitstream. The encoder may, for example, use rate-distortion optimization when selecting whether or not the intra prediction and prediction error coding/decoding use the same block partitioning.

### Depth-Based Intra Prediction Mode Determination

The encoder and/or the decoder may determine an intra-prediction mode by using the depth information. In some embodiments, the depth of the current texture block being coded or decoded is compared to the depth of the neighboring texture blocks or boundary samples of the depth blocks co-located or corresponding to the neighboring texture blocks, and the intra prediction mode of the current texture block is determined on the basis of this comparison. For example, if the depth of the current texture block is very similar to the depth of the boundary samples, a DC prediction may be inferred. In another example, a depth boundary is detected in the current depth block and a bi-directional intra prediction for the current texture block is inferred.

As the intra prediction mode may be inferred in the encoder and the decoder, no syntax element may be coded and bitrate may be reduced. The use of depth-based intra prediction mode determination may be signaled for example in the slice header and the encoder may turn a depth-based intra prediction mode on using rate-distortion optimized decision comparing a depth-based prediction mode determination and a conventional intra prediction mode determination and syntax element coding.

In some embodiments, the intra prediction mode of the depth block is used for intra prediction of the respective or co-located texture block (in both the encoder and decoder).

In some embodiments, the depth of the current texture block being coded or decoded is compared to the depth of the neighboring texture blocks or boundary samples of the depth blocks co-located or corresponding to the neighboring texture blocks, and the intra prediction mode of the current texture block is determined on the basis of this comparison. For example, if the depth of the current texture block is very similar to the depth of the boundary samples, a DC prediction may be inferred or a conventional intra prediction mode signaling may be inferred. In another example, a depth boundary is detected in the current depth block and a bi-directional intra prediction for the current texture block is inferred.

Similarly to the block partitioning, there are multiple options for entropy coding of the intra prediction mode, including the following. The bi-directional intra prediction mode may be inferred when there is a depth boundary within the block, and otherwise conventional intra prediction is used for the block, where encoder determines the intra prediction mode and indicates it in the bitstream. As the intra prediction mode is inferred in both the encoder and decoder, no syntax element is coded.

In another option, the intra prediction mode is coded into the bitstream but the depth-based prediction of the intra prediction mode is applied in both encoder and decoder to modify the context state of CABAC or context-based variable length coding or any similar entropy coding in such a manner that the intra prediction mode chosen by the depth-based algorithm uses smaller amount of coded data bits. In effect, the likelihood of the intra prediction mode deduced by the depth-based algorithm may be increased in the entropy coding and decoding.

In yet another option the intra prediction mode is coded into the bitstream but the code table or binarization table used in the intra prediction mode codeword is dependent on the result of the depth-based algorithm.

The use of depth-based intra prediction mode determination may be signaled for example in the slice header, macroblock syntax, or block syntax and the encoder may turn it on using rate-distortion optimized decision comparing depth-based prediction mode determination and conventional intra prediction mode determination.

The encoder may, for example, perform conventional intra prediction mode selection e.g. using rate-distortion optimization. If the rate-distortion cost of conventional intra prediction is smaller than that of the depth-based intra prediction mode selection, the encoder may choose to use conventional intra prediction and indicate the use of the conventional intra prediction in the bitstream, for example in the slice header, macroblock syntax, or block syntax.

The decoder may decode the syntax element(s) related to the intra prediction mode and decode the bitstream using the indicated intra prediction mode and related syntax elements.

### Depth-Based Sample Availability for Intra Prediction

The encoder and/or the decoder may also determine whether there exist one or more samples for intra prediction. In some embodiments, only samples that are classified in encoding and/or decoding to belong to the same object using as a sample being predicted are used as a prediction source. The classification to the same object may be done e.g. through comparing depth sample values.

In an example implementation, the encoder and/or decoder decisions on the intra coding mode and macroblock partitioning as well as on the intra prediction mode decisions for texture blocks may be done independently of the respective depth pictures. However, the availability information of texture samples for intra prediction may be modified according to the available depth information.

In the following an embodiment of the depth-based sample availability for intra prediction determination is described for 4×4 intra prediction for luma. The method is similarly applicable to 8×8 and 16×16 intra prediction for luma as well as the intra prediction for chroma. The method is also similarly available to other block sizes and shapes.

The encoder and/or the decoder may use e.g. boundary comparison or pseudo-prediction of depth for the determination whether luma samples A to M, with reference to FIG. 8, are in the same depth range as the luma samples being predicted:

In some embodiments the boundary comparison may be performed as follows. With reference to FIG. 8, the availability of luma samples A to M for prediction of samples a to p may be determined as follows. A threshold value t1 may be pre-defined. The sample A is marked as “not available for intra prediction” if abs (d(A)−d(a))>=t1, where function abs(x) returns the absolute value of x. Correspondingly, sample B is marked as “not available for intra prediction” if abs (d(B)−d(b))>=t1, sample C is marked as “not available for intra prediction” if abs (d(C)−d(c))>=t1, and sample D is marked as “not available for intra prediction” if abs (d(D)−d(d))>=t1.

Similarly, a sample from I to L is marked as “not available for intra prediction” if abs (d(I)−d(a))>=t1, abs (d(J)−d(e))>=t1, abs (d(K)−d(i))>=t1, abs (d(L)−d(m))>=t1, respectively.

The sample M is marked as “not available for intra prediction” if abs (d(M)−d(a))>=t1.

There are at least two possibilities for determining sample availability of samples E to H for intra prediction—either boundary comparison rules are not defined for E to H (and possibly avoid using those prediction modes in luma texture coding), or the boundary matching rules are defined according to the prediction mode so that the closest sample d to p that intersects with the prediction direction of E to H is chosen to the comparison.

### Pseudo-Prediction of Depth

In some embodiments the constraints for evaluating the availability of samples A to M for intra prediction of the luma component of a texture view component may be as follows. Rules defined in H.264/AVC, i.e. the rules in H.264/AVC for marking samples A to M as “available for intra prediction” and “not available for intra prediction” may be applied first and then additional samples A to M are marked as “not available for intra prediction” according to the process below.

Let the co-located depth sample value for a luma pixel be marked as d(x), where x can be any of the sample positions A to M and a to p.

Let a depth pseudo-prediction value for a sample position x from a to p, dpp(x), be specified by applying the selected luma texture intra prediction mode for the co-located depth block. For example, if a vertical 4×4 intra prediction is applied (or tested in RD optimization) luma texture, dpp(a)=dpp(e)=dpp(i)=dpp(m)=d(A); dpp(b)=dpp(f)=dpp(j)=dpp(n)=d(B); dpp(c)=dpp(g)=dpp(k)=dpp(o)=d(C); dpp(d)=dpp(h)=dpp(l)=dpp(p)=d(D).

Another threshold t2 may be pre-defined that is used to determine whether a depth pseudo-prediction value is sufficiently good.

Sample A to M is marked not available for intra prediction if any one of the depth pseudo-prediction values that it contributes to, dpp(z) where z is a set of pseudo-prediction values where sample A to M contributes, is greater than the threshold t2.

In some embodiments, the encoder may indicate the determined values of the thresholds t1 and/or t1 and/or the method used for sample availability determination for intra prediction within the bitstream, for example by encoding them as one or more syntax elements for example in a sequence parameter set, a picture parameter set, a slice parameter set, a picture header, a slice header, within a macroblock syntax structure, or anything alike. In some embodiments, the decoder determines the thresholds t1 and/or t2 and/or the method used for sample availability determination for intra prediction based on the information encoded in the bistream, such as one or more codewords indicating the value of thresholds t1 and/or t2 and/or the method for sample availability determination for intra prediction.

### Bi-Directional Intra Prediction for Blocks Containing a Depth Boundary

It is also possible that the encoder and the decoder use bi-directional intra prediction for texture blocks containing a depth boundary. Bi-directional intra prediction may be more efficient when the depth components are encoded and decoded before the texture components. Hence, the depth components of possibly all neighboring blocks of the current block may be available when encoding or decoding the texture components of the current block.

In some embodiments a texture block to be coded or decoded may be divided into two or more depth regions. The boundary samples of neighboring texture blocks are classified in encoding and/or decoding also to the equivalent two or more depth regions. Samples within a particular depth region in the block being coded or decoded may then be predicted only from the respective boundary samples of the neighboring blocks. Different prediction direction or intra prediction mode may be selected for different regions.

One or more of the following steps may be performed for bi- or multi-directional intra prediction of texture blocks containing a depth boundary.

a. A new intra prediction mode for bi-directional intra prediction is specified in addition to the regular intra modes as specified below.

b. The encoder makes a rate-distortion optimized decision of the block partitioning, such as macroblock or treeblock partitioning, and the coding modes used by including the new bi-directional ultra prediction as one of the tested modes. As a generalization, there could be more than two intra prediction directions, i.e. tri-directional intra prediction or generally n-directional intra prediction, where n is a positive integer.

c. If the texture block (of any size and shape such as 16×16, 8×8, and 4×4) contains a depth boundary, the availability of block boundary samples at neighboring blocks is determined, e.g. A to D and I to M in the example of FIG. 1. In some embodiments, the block or macroblock coding and decoding order is changed, and the block to be predicted may be surrounded from up to four sides by available block boundary samples at neighboring blocks.

d. If the available block boundary samples at neighboring texture blocks co-locate with depth samples that are from different depth ranges, then bi-directional intra prediction mode is available for the encoder and/or the decoder.

The availability of the bi-directional intra prediction mode may be used to tune entropy coding e.g. by setting the probability of the bi-directional intra mode to zero in CABAC or selecting a code table that excludes the bi-directional intra mode in context-adaptive variable-length coding if the bi-directional intra prediction mode is not available.

e. Two most prominent depth regions may be selected in encoding and/or decoding from the available block boundary depth samples at neighboring blocks and from the depth block that co-locates the texture block being coded. For example, the two depth regions having the most samples in the depth block may be selected provided that block boundary depth samples at neighboring blocks for them are also available.

f. Each sample in the depth block may be mapped to one of the two most prominent depth regions, e.g. according to closest absolute difference to the median or average depth value of the depth region. As a result each sample in the texture block being coded is mapped either depth region, which may be denoted as a depth region 0 or a depth region 1.

Steps e and f may be performed for example as follows: Let Dmax and Dmin be the maximum value and minimum value, respectively, in the reconstructed depth block that co-locates the texture block. Let a threshold value DThres=(Dmax+Dmin)/2. Samples in depth region 0 are such that for which depth <=DThres. Samples in depth region 1 are such that for which depth >DThres.

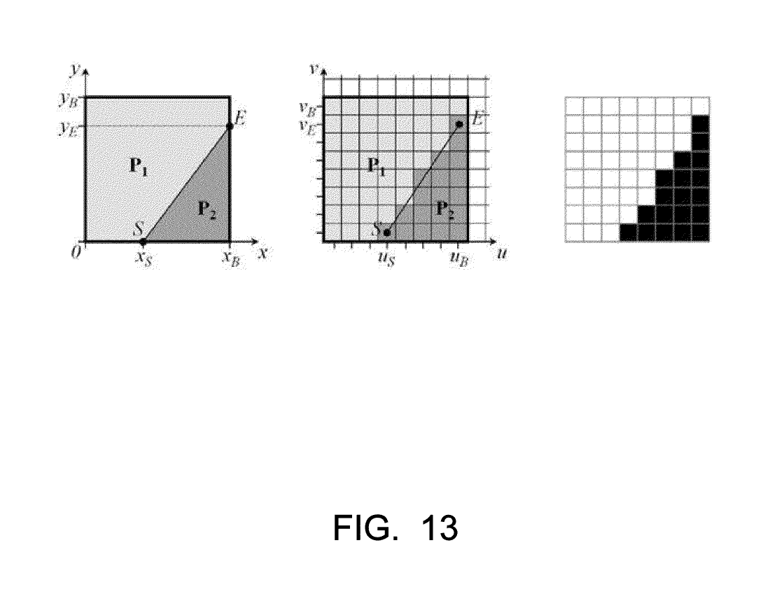

In some embodiments, the depth regions may be determined to be contiguous. For example, a Wedgelet partitioning may be used in both encoder and decoder. For a Wedgelet partition, the two regions are defined to be separated by a straight line. The separation line is determined by the start point S and the end point P, both located on different borders of the block. For the continuous signal space (see FIG. 13, left), the separation line can be described by the equation of a straight line. The middle image of FIG. 13 illustrates the partitioning for the discrete sample space. Here, the block consists of an array of samples and the start and end points correspond to border samples. Although the separation line can be described by a line equation as well, the definition of regions is different here, as only complete samples can be assigned as a part of either of the two regions.

The start and end point for the Wedgelet partitioning may be determined for example by minimizing a cost function as follows. Different possibilities for S and P are tested and the respective cost is derived. For example, all possible combinations of S and P may be tested. For each pair of S and P, a representative value for region 0 and 1 is first determined for example by averaging the depth sample values in region 0 and 1, respectively. Then a cost may be counted for example by deriving a sum of absolute differences of the depth samples relative to the representative value of region 0 or 1, depending on which region the depth sample has been divided according to S and P. The values of S and P minimizing the cost are selected for the Wedgelet partitioning.

In some embodiments, the depth regions may be determined to be contiguous but are not required to be separated by a straight line.

g. Intra prediction for the texture block is performed separately for depth region 0 and depth region 1. Different intra prediction direction may be selected for depth region 0 than for depth region 1. The prediction direction may be inferred by both the encoder and decoder. Alternatively, the prediction direction may be determined by the encoder and signaled in the bitstream. In the latter case, two prediction direction codewords are coded, one for depth region 0 and another for depth region 1.

The sample availability for intra prediction may be depth-based, e.g. as described above. Another similar alternative is to classify the samples in the neighboring blocks that may be used for intra prediction to region 0 or region 1 by comparing their depth value with the threshold DThres. Samples from neighboring blocks classified in region 0 may be used to predict the samples of the region 0 in the current block being coded or decoded, and samples from neighboring blocks classified in region 1 are not used to predict the samples of the region 0 in the current block being coded or decoded. Region 1 of the current block being coded or decoded may be handled similarly.

In some embodiments the block or macroblock coding or decoding order is changed, and a block to be predicted may be surrounded from up to four sides by available block boundary samples at neighboring blocks, and hence the intra prediction modes and the block boundary samples at neighboring blocks that they use may also differ from those currently in H.264/AVC or HEVC or any similar coding or decoding method or system. For example, the H.264/AVC intra prediction modes may be changed as follows.

In DC mode the region 0/1 is set to be the mean value of samples at neighboring blocks that surround the current block from any direction and that are also in the region 0/1.

In horizontal/vertical mode, if boundary samples of blocks from both sides of the current block are available, the boundary samples are weighted according to the Euclidean spatial distance to the sample being predicted. For example, if a horizontal coordinate of prediction sample p1 is x1=7 and a horizontal coordinate of prediction sample p2 is x2=16 and a horizontal coordinate of the sample being predicted is x=10, and horizontal prediction is used, the prediction sample may be derived using m=(x2−x1)=9 as ((m−(x−x1))*p1+(m−(x2−x))*p2)/m=((9−(10−7))*p1+(9−(16−10))*p2)/9=(6*p1+3*p2)/9. If only one boundary sample is available, it is used as such as a prediction. If no boundary samples are available, the value obtained by through DC prediction may be used.

### Depth-Weighted Intra Prediction

In some embodiments the encoder and the decoder use the depth information for weighting purposes in intra prediction. In some embodiments, the depth-based weight for intra prediction of texture may be a non-binary value, such as a fractional value, that is based on the difference between the depth of the texture sample being predicted and the depth of the prediction sample.

In some embodiments above, more than one prediction sample is used for predicting a single sample. Furthermore, in some embodiments, a binary weight based has been used, i.e. if a prediction sample is classified to belong to a different depth region as the sample being predicted, a weight of 0 may be used. Otherwise, an equal weight for all prediction samples may be used. In some embodiments, an additional multiplicative weight may have been determined based on Euclidean spatial distance between the prediction sample and the sample being predicted.

In some embodiments, the depth-based weight may be a non-binary value, such as a fractional value. For example, the following derivation may be used. Let the depth value of the sample being predicted be denoted d. Let the prediction samples be denoted pi and the depth value of prediction samples be denoted di, where i is an index of the prediction samples. The depth of prediction samples may also include values that are derived from multiple depth samples, such as the average of all boundary samples of neighboring depth blocks that classified to belong to the same depth region as the depth of the sample being predicted. The prediction samples may be selected according to any embodiment above. Let S be equal to Σabs(di−D) over all values of i=1 to n, inclusive, where n is the number of prediction samples. Let wi defined for each prediction be equal to (S−Σabs(dj−D))/S for values of j=1 to n, inclusive, where j≠i. The prediction sample p may then be derived as Σ(wi*pi) over all values of i=1 to n, inclusive.

Obtaining Depth/Disparity Information for Current Texture Block being Coded or Decoded

There may be several different ways to obtain depth/disparity information for the current texture block being coded or decoded. For example, the coding order or decoding order of view components may be such that a depth view component is coded or decoded before the respective texture view component. In this example the respective texture view component is the texture view component of the same view as the depth view component.

According to another example, a depth view component follows in coding or decoding order the respective texture view component. However, the coding or decoding of the depth and texture view components is performed in a synchronous manner such that the coding or decoding order of blocks of the depth view component and the respective texture view component is interleaved. However, the coding or decoding of a depth block follows, in coding or decoding order, the coding or decoding of the co-located texture block due to potential prediction dependencies from the texture block to the depth block. In order to obtain depth/disparity information for the current texture block being coded or decoded, the depth/disparity information may be predicted or estimated from one or more of the neighboring blocks.

According to a third example, a depth view component follows, in coding or decoding order, the respective texture view component. The depth/disparity information is predicted or estimated from earlier coded or decoded view components and/or access units.

The used depth/disparity estimation method may be selected by the encoder e.g. through rate-distortion optimization and may be indicated by the encoder as a syntax element or elements or a value of a syntax element in the coded bitstream. The syntax element(s) may reside for example in a sequence parameter set, picture parameter set, adaptation parameter set, picture header, or slice header.

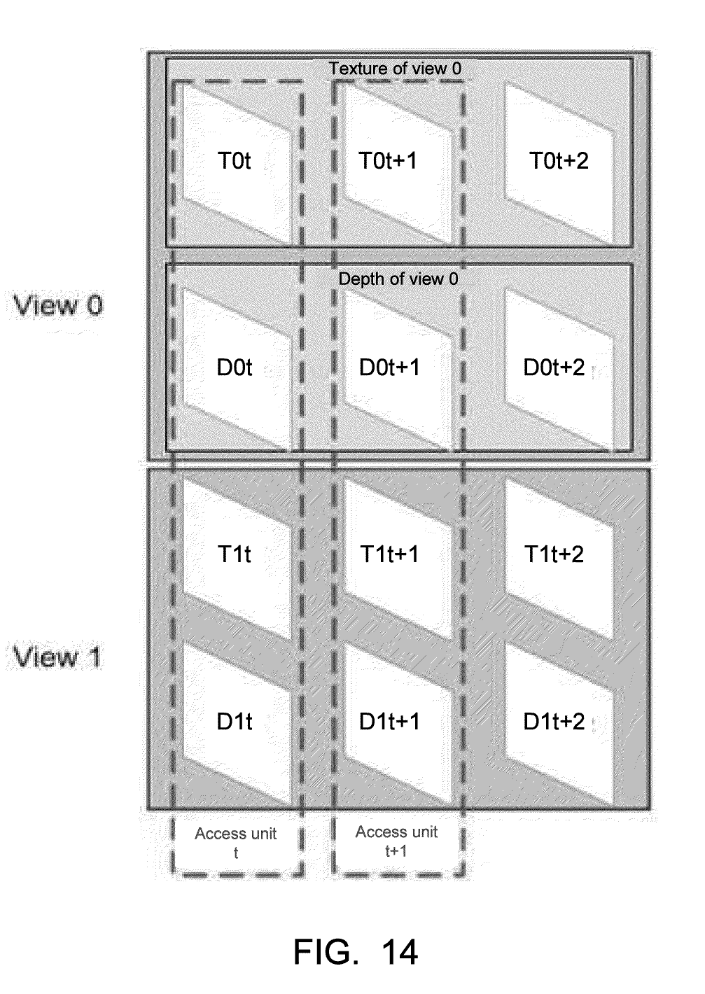

In many embodiments the coding order of texture and depth view components within an access unit is such that the data of a coded view component is not interleaved by any other coded view component, and the data for an access unit is not interleaved by any other access unit in the bitstream/decoding order. For example, there may be two texture and depth views (T0ₜ, T1_{T}, T0ₜ₊₁, T1ₜ₊₁, T0ₜ₊₂, T1ₜ₊₂, D0ₜ, D1ₜ, D0ₜ₊₁, D0ₜ₊₂, D1ₜ₊₂) in different access units (t, t+1, t+2), as illustrated in FIG. 14, where the access unit t consisting of texture and depth view components (T0ₜ,T1ₜ, D0ₜ,D1t) precedes in bitstream and decoding order the access unit t+1 consisting of texture and depth view components (T0ₜ₊₁,T1ₜ₊₁, D0ₜ₊₁,D1ₜ₊₁).

In many embodiments each texture view component is coded before the respective depth view component. Each texture view component of enhanced texture views is coded after the respective depth view component. The texture and depth view components of the same access units are coded in view dependency order. Texture and depth view components can be ordered in any order with respect to each other as long as the ordering obeys the mentioned constraints. Examples of coding order for an access unit include but are not limited to the following. In a first example the texture components T0, T1 of the access unit are coded before the respective depth components D0, D1, i.e. T0, T1, D0, D1 . . . . In this example the views could comprise two AVC/MVC compatible texture views. In a second example the texture and depth components T0, D0 of the first access unit are decoded before texture and depth components T1, D1 of the second access unit, i.e. T0, D0, T1, D1 . . . . In this example the views could comprise two AVC/MVC compatible texture views. In a third example the texture and depth components T0, D0 of the first access unit are decoded before the depth and texture components T1, D1 of the second access unit and further the depth component D1 of the second access unit is coded before the texture component T1 of the second access unit, i.e. T0, D0, D1, T1 . . . . In this example the views could comprise one AVC compatible texture view and one enhanced texture view. In a fourth example the texture and depth components of one access unit are sequentially coded before sequentially coding the texture and depth components of another access unit. In this example the coding order of the texture and depth components within an access unit may be such that the depth component is coded before the texture component, i.e. D0, T0, D1, T1 . . . . In this example the views could comprise two enhanced texture views but no AVC compatible texture views.

When the depth view component precedes the texture view component of the same view in coding or decoding order, the depth/disparity information for coding or decoding of any texture block is available through reconstructing/decoding the depth view component.

In some embodiments the coding/decoding order of texture and depth may be interleaved using smaller units than view components, such as on block or slice basis. The respective coding/decoding order of coded texture and depth units, such as blocks, may follow the ordering rules described in the previous paragraph. For example, there may be two spatially adjacent texture blocks, ta and tb, where tb follows ta in coding/decoding order, and two depth/disparity blocks, da and db, spatially co-located with ta and tb, respectively. When prediction parameters for ta and tb are derived with the assistance of da and db, respectively, the coding/decoding order of the blocks may be (da, ta, db, tb) or (da, db, ta, tb). The bitstream order of the blocks may be the same as their coding order.

In some embodiments the coding/decoding order of texture and depth may be interleaved using greater units than view components, such as one or more groups of pictures or one or more coded video sequences.

Texture views and depth views may be coded into a single bitstream where some of the texture views may be compatible with one or more video standards such as H.264/AVC and/or MVC. In other words, a decoder may be able to decode some of the texture views of such a bitstream and can omit the remaining texture views and depth views.

In this context an encoder that encodes one or more texture and depth views into a single H.264/AVC and/or MVC compatible bitstream is also called as a 3DV-ATM encoder. Bitstreams generated by such an encoder can be referred to as 3DV-ATM bitstreams. The 3DV-ATM bitstreams may include some of the texture views that H.264/AVC and/or MVC decoder cannot decode, and depth views. A decoder capable of decoding all views from 3DV-ATM bitstreams may also be called as a 3DV-ATM decoder.

3DV-ATM bitstreams can include a selected number of AVC/MVC compatible texture views. The depth views for the AVC/MVC compatible texture views may be predicted from the texture views. The remaining texture views may utilize enhanced texture coding and depth views may utilize depth coding.

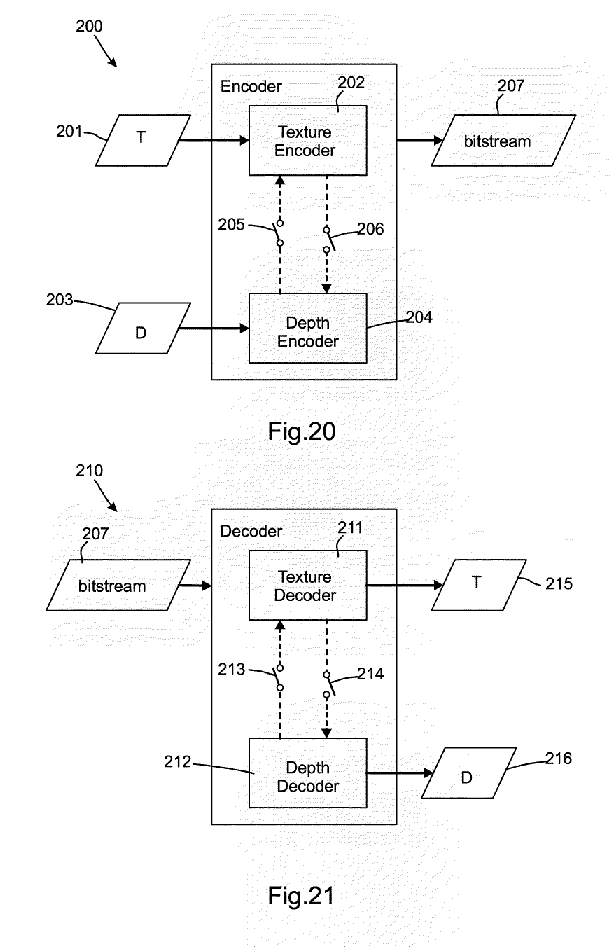

A high level flow chart of an embodiment of an encoder 200 capable of encoding texture views and depth views is presented in FIG. 20 and a decoder 210 capable of decoding texture views and depth views is presented in FIG. 21. On these figures solid lines depict general data flow and dashed lines show control information signaling. The encoder 200 may receive texture components 201 to be encoded by a texture encoder 202 and depth map components 203 to be encoded by a depth encoder 204. When the encoder 200 is encoding texture components according to AVC/MVC a first switch 205 may be switched off. When the encoder 200 is encoding enhanced texture components the first switch 205 may be switched on so that information generated by the depth encoder 204 may be provided to the texture encoder 202. The encoder of this example also comprises a second switch 206 may be operated as follows. The second switch 206 is switched on when the encoder is encoding depth information of AVC/MVC views, and the second switch 206 is switched off when the encoder is encoding depth information of enhanced texture views. The encoder 200 may output a bitstream 207 containing encoded video information.

The decoder 210 may operate in a similar manner but at least partly in a reversed order. The decoder 210 may receive the bitstream 207 containing encoded video information. The decoder 210 comprises a texture decoder 211 for decoding texture information and a depth decoder 212 for decoding depth information. A third switch 213 may be provided to control information delivery from the depth decoder 212 to the texture decoder 211, and a fourth switch 214 may be provided to control information delivery from the texture decoder 211 to the depth decoder 212. When the decoder 210 is to decode AVC/MVC texture views the third switch 213 may be switched off and when the decoder 210 is to decode enhanced texture views the third switch 213 may be switched on. When the decoder 210 is to decode depth of AVC/MVC texture views the fourth switch 214 may be switched on and when the decoder 210 is to decode depth of enhanced texture views the fourth switch 214 may be switched off. The Decoder 210 may output reconstructed texture components 215 and reconstructed depth map components 216.

In some embodiments both the encoder 200 and the decoder 210 may estimate the depth/disparity information from the neighboring reconstructed/decoded depth/disparity blocks. The estimation may be performed, for example, as follows.

For each depth/disparity block to be estimated, the gradient values are measured along nine intra prediction directions based on the neighboring left and upper blocks, and then the prediction mode resulting in the smallest gradient is selected to obtain an estimate of this depth/disparity block. Alternatively, the same gradient based block estimation process can be performed for the current texture block being coded or decoded and the prediction mode resulting in the smallest gradient is selected to be used as the prediction mode to obtain the estimated depth/disparity block from its neighboring depth/disparity blocks. Alternatively, the same gradient based estimation process can be performed for both the depth/disparity information and the texture block being coded or decoded, and a weighted sum of the gradients of the estimated depth/disparity and texture can be used to select the smallest weighted gradient and the prediction direction to be used to obtain the estimated depth/disparity block.

In some embodiments the gradient may be calculated as follows (taking a 4×4 block for an example):

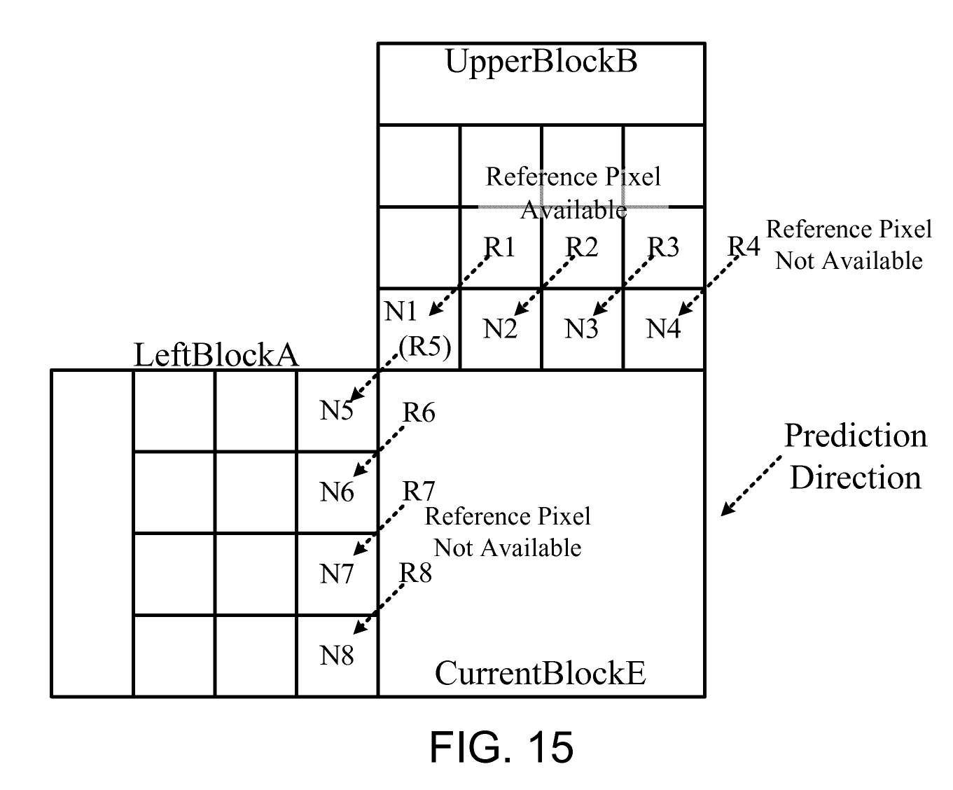

For pixels N1 to N8, their reference pixel R1 to R8 is found along a prediction direction (pd), except for the DC mode. The reference pixel of Ni (i=1, 2 . . . , 8) is the nearest integer pixel along the opposite of the prediction direction from the pixel Ni, as shown in FIG. 15. A reference pixel may not be available when the reference pixel is outside the neighboring left or upper blocks. The gradient, indicating the direction of the texture, is formulated as

$$G ( p d ) = \frac{{\sum }_{i = 1}^{8} {( {N}_{i} - {R}_{i} )}^{2} \cdot {W}_{i}}{{\sum }_{i = 1}^{8} {W}_{i}} , \\ p d \neq DC mode , \\ {W}_{i} = \{ \begin{matrix}1 , & if {R}_{i} is available in A or B \\ 0 , & otherwise\end{matrix}$$

For the DC mode, the gradient is based on the variance of neighboring pixels N1 to N8:

G(pd)=Var(N)·w,pd=DC mode

where w is a weight to unify the two ways of gradient calculation, may be set for example as 0.5.

The gradient-based most probable mode (GMPM) for other block sizes is similar, except for the number of neighboring pixels and their reference pixels.

In this example, only pixels in the left three columns and upper three rows (in light blue) are used in the gradient calculation for different prediction modes.

In the following, two example methods are described by which a suitable estimate for the depth map of the current texture view component can be derived based on already transmitted information.

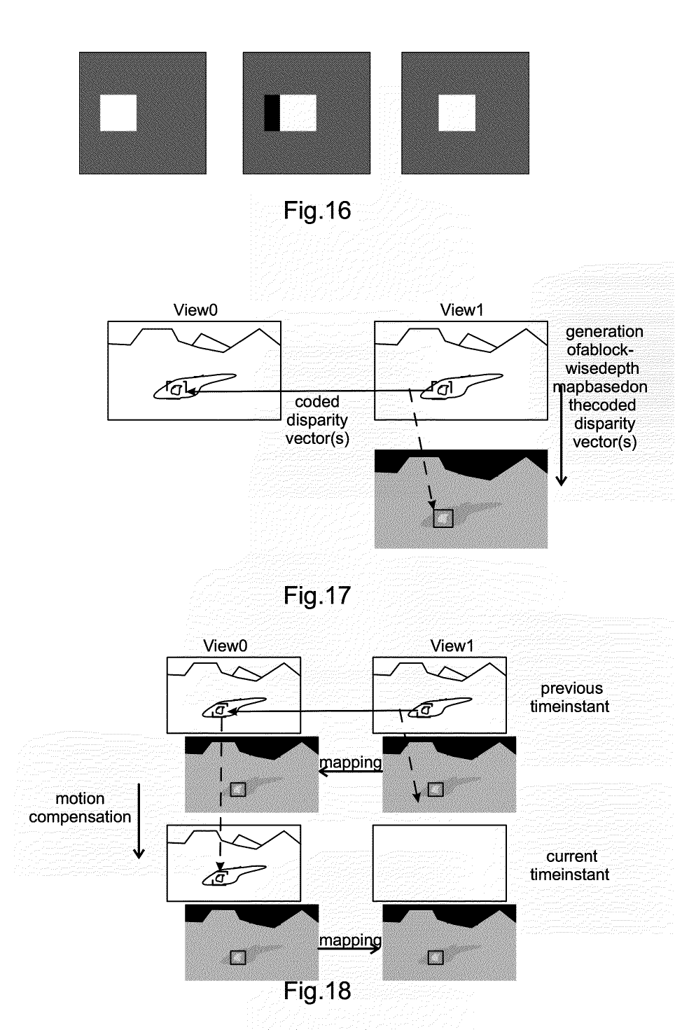

In the first method the depth data is transmitted as a part of the bitstream, and a decoder using this method decodes the depth maps of previously coded views for decoding dependent views. In other words, the depth map estimate can be based on an already coded depth map. If the depth map for a reference view is coded before the current picture, the reconstructed depth map can be mapped into the coordinate system of the current picture for obtaining a suitable depth map estimate for the current picture. In FIG. 16, such a mapping is illustrated for a simple depth map, which consists of a square foreground object and background with constant depth. For each sample of the given depth map, the depth sample value is converted into a sample-accurate disparity vector. Then, each sample of the depth map is displaced by the disparity vector. If two or more samples are displaced to the same sample location, the sample value that represents the minimal distance from the camera (i.e., the sample with the larger value in some embodiments) is chosen. In general, the described mapping leads to sample locations in the target view to which no depth sample value is assigned. These sample locations are depicted as a black area in the middle of the picture of FIG. 16. These areas represent parts of the background that are uncovered due to the movement of the camera and can be filled using surrounding background sample values. A simple hole filling algorithm may be used which processes the converted depth map line by line. Each line segment that consists of a successive sample location to which no value has been assigned is filled with the depth value of the two neighboring samples that represent a larger distance to the camera (i.e., the smaller depth value in some embodiments).

The left part of FIG. 16 illustrates the original depth map; the middle part illustrates the converted depth map after displacing the original samples; and the right part illustrates the final converted depth map after filling of holes.

In the second example method the depth map estimate is based on coded disparity and motion vectors. In random access units, all blocks of the base view picture, are intra-coded. In the pictures of dependent views, most blocks are typically coded using disparity-compensated prediction (DCP, also known as inter-view prediction) and the remaining blocks are intra-coded. When coding the first dependent view in a random access unit, no depth or disparity information is available. Hence, candidate disparity vectors can only be derived using a local neighborhood, i.e., by conventional motion vector prediction. But after coding the first dependent view in a random access unit, the transmitted disparity vectors can be used for deriving a depth map estimate, as it is illustrated in FIG. 17. Therefore, the disparity vectors used for disparity-compensated prediction are converted into depth values and all depth samples of a disparity-compensated block are set equal to the derived depth value. The depth samples of intra-coded blocks are derived based on the depth samples of neighboring blocks; the used algorithm is similar to spatial intra prediction. If more than two views are coded, the obtained depth map can be mapped into other views using the method described above and used as a depth map estimate for deriving candidate disparity vectors.

The depth map estimate for the picture of the first dependent view in a random access unit is used for deriving a depth map for the next picture of the first dependent view. The basic principle of the algorithm is illustrated in FIG. 18. After coding the picture of the first dependent view in a random access unit, the derived depth map is mapped into the base view and stored together with the reconstructed picture. The next picture of the base view may typically be inter-coded. For each block that is coded using a motion compensated prediction (MCP), the associated motion parameters are applied to the depth map estimate. A corresponding block of depth map samples is obtained by motion compensated prediction with the same motion parameters as for the associated texture block; instead of a reconstructed video picture the associated depth map estimate is used as a reference picture. In order to simplify the motion compensation and avoid the generation of new depth map values, the motion compensated prediction for depth block may not involve any interpolation. The motion vectors may be rounded to sample-precision before they are used. The depth map samples of intra-coded blocks are again determined on the basis of neighboring depth map samples. Finally, the depth map estimate for the first dependent view, which is used for the inter-view prediction of motion parameters, is derived by mapping the obtained depth map estimate for the base view into the first dependent view.

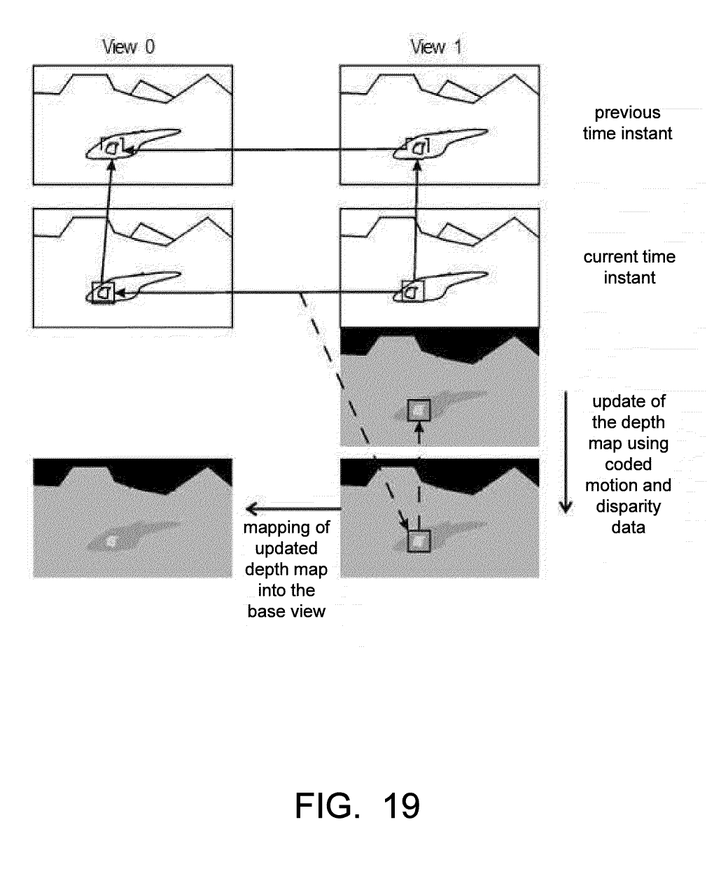

After coding the second picture of the first dependent view, the estimate of the depth map is updated based on actually coded motion and disparity parameters, as it is illustrated in FIG. 19. For blocks that are coded using disparity-compensated prediction, the depth map samples are obtained by converting the disparity vector into a depth value. The depth map samples for blocks that are coded using motion compensated prediction can be obtained by motion compensated prediction of the previously estimated depth maps, similar as for the base view. In order to account for potential depth changes, a mechanism by which new depth values are determined by adding a depth correction may be used. The depth correction is derived by converting the difference between the motion vectors for the current block and the corresponding reference block of the base view into a depth difference. The depth values for intra-coded blocks are again determined by a spatial prediction. The updated depth map is mapped into the base view and stored together with the reconstructed picture. It can also be used for deriving a depth map estimate for other views in the same access unit.

For the following pictures, the described process is repeated. After coding the base view picture, a depth map estimate for the base view picture is determined by motion compensated prediction using the transmitted motion parameters. This estimate is mapped into the second view and used for the inter-view prediction of motion parameters. After coding the picture of the second view, the depth map estimate is updated using the actually used coding parameters. At the next random access unit, the inter-view motion parameter prediction is not used, and after decoding the first dependent view of the random access unit, the depth map may be re-initialized as described above.

While the invention has been largely described using H.264/AVC, MVC, and 3DV-ATM as basis, it can be applied for other codecs, bitstream formats, and coding structures too. For example, the invention can be applied to HEVC-based depth-enhanced video coding, such as 3DV-HTM described in MPEG document M12354.

In some embodiments, depth is coded at a different spatial resolution than texture. Therefore, scaling according to the proportion of the spatial resolutions may be taken into account in the determination of co-located or respective blocks in texture and depth view components. Similarly, the size of block partitions may be scaled according to the proportion of the spatial resolutions in the prediction of block partitions from depth to texture.

In the following, some parameters relating to many embodiments are described.

### Disparity Estimation

It is assumed herein that the based depth or disparity information associated with currently coded block of texture data is utilized in intra prediction decisions, and therefore it is assumed that the depth or disparity information is available at the decoder side in advance. In some MVD systems, the texture data (2D video) is coded and transmitted along with pixel-wise depth map or disparity information. Thus, a coded block of texture data (cb_t) can be pixel-wise associated with a block of depth/disparity data (cb_d). The latter can be utilized in the proposed intra prediction chains without modifications.

In some embodiments, instead of the depth map data the actual disparity information or at least an estimate of it may be used. Thus, a conversion from the depth map data to disparity information may be required. The conversion may be performed as following:

$$z = \frac{1}{\frac{v}{255} \cdot ( \frac{1}{Z {1}_{near}} - \frac{1}{Z {1}_{far}} ) + \frac{1}{Z {1}_{far}}} d = \frac{f \cdot b}{z} ; \qquad ( 2 )$$

where v is a depth map value, z is the actual depth value, and d is the resulting disparity. The parameters f, b, Zₙₑₐᵣ and Z_{far} derived from the camera setup; i.e. the used focal length (f), camera separation (b) and depth range (Zₙₑₐᵣ,Z_{far}) respectively.

According to an embodiment, the disparity information may be estimated from the available textures at the encoder/decoder sides through a block matching procedure or any other means.

Depth and/or Disparity Parameters of a Block

The pixels of a coded block of texture (cb_t) can be associated with a block of depth information (cb_d) for each of said pixels. The depth/disparity information can be aggregatively presented through average depth/disparity values for cb_d and deviation (e.g. variance) of cb_d. The average Av(cb_d) depth/disparity value for a block of depth information cb_d is computed as:

Av(cb_{—}d)=sum(cb_{—}d(x,y))/num_pixels, (3)

where x and y are coordinates of the pixels in cb_d, and num_pixels is number of pixels within cb_d, and function sum adds up all the sample/pixel values in the given block, i.e. function sum(block(x,y)) computes a sum of samples values within the given block for all values of x and y corresponding to the horizontal and vertical extents of the block.

The deviation Dev(cb_d) of the depth/disparity values within a block of depth information cb_d can be computed as:

Dev(cb_{—}d)=sum(abs(cb_{—}d(x,y)−Av(cb_{—}d)))/num_pixels (4)

where function abs returns the absolute value of the value given as input. For determining those coded blocks of texture, which are associated with homogenous depth information, an application-specific predefined threshold T1 can be defined such that:

If Dev(cb_{—}d)=<T1,cb_{—}d=homogenous data (5)

In other words, if the deviation of the depth/disparity values within a block of depth information cb_d is less than or equal than the threshold T1, such cb_d block can be considered as homogenous.

The coded block of texture data cb can be compared to its neighboring blocks nb through their depth/disparity information. The selection of the neighboring block nb may be determined for example based on the coding mode of cb. The average deviation (difference) between the current coded depth/disparity block (cb_d) and each of its neighboring depth/disparity blocks (nb_d) can be computed as:

nsad(cb_{—}d & nb_)=sum(abs(cb_{—}d(x,y)−nb_{—}d(x,y)))/num_pixels. (6)

where x and y are coordinates of the pixels in cb_d, and in its neighboring depth/disparity block (nb_d), num_pixels is the number of pixels within cb_d and functions sum and abs are defined above.

In various embodiments, the similarity of two depth/disparity blocks is compared. The similarity may be compared for example using equation (6) but any other similarity or distortion metric may also be used. For example, a sum of squared differences normalized by the number of pixels may be used as computed in equation (7):

nsse(cb_{—}d,nb_{—}d)=sum((cb_{—}d(x,y)−nb_{—}d(x,y))̂2)/num_pixels (7)

where x and y are coordinates of the pixels in cb_d and in its neighboring depth/disparity block (nb_d), num_pixels is number of pixels within cb_d, notation ̂2 indicates a power of two, and function sum is defined above.

In another example, a sum of transformed differences may be used as a similarity or distortion metric. Both the current depth/disparity block cb_d and a neighboring depth/disparity block nb_d are transformed using for example a discrete cosine transform (DCT) or a variant thereof, herein marked as function T( ). Let tcb_d be equal to T(cb_d) and tnb_d be equal to T(nb_d). Then, either the sum of absolute or squared differences is calculated and may be normalized by the number of pixels/samples, num_pixels, in cb_d or nb_d, which is also equal to the number of transform coefficients in tcb_d or tnb_d. In equation (8), the version of sum of transformed differences using sum of absolute differences is given:

nsatd(cb_{—}d,nb_{—}d)=sum(abs(tcb_{—}d(x,y)−tnb_{—}d(x,y)))/num_pixels (8)

Other distortion metrics, such as the structural similarity index (SSIM), may also be used.

Function diff(cb_d, nb_d) may be defined as follows to enable access any similarity or distortion metric:

diff(cb_{—}d,nb_{—}d)=nsad(cb_{—}d,nb_{—}d), if sum of absolute differences is used nsse(cb_{—}d,nb_{—}d), if sum of squared differences is used nsatd(cb_{—}d,nb_{—}d), if sum of transformed absolute differences is used (9)

Any similarity/distortion metric could be added to the definition of function diff in equation (9). In some embodiments, the used similarity/distortion metric is pre-defined and therefore stays the same in both the encoder and the decoder. In some embodiments, the used similarity/distortion metric is determined by the encoder, for example using rate-distortion optimization, and encoded in the bitstream as an indication. The indication of the used similarity/distortion metric may be included for example in a sequence parameter set, a picture parameter set, a slice parameter set, a picture header, a slice header, within a macroblock syntax structure, or anything alike. In some embodiments, the indicated similarity/distortion metric may be used in pre-determined operations in both the encoding and the decoding loop, such as depth/disparity based motion vector prediction. In some embodiments, the decoding processes for which the indicated similarity/distortion metric is indicated are also indicated in the bitstream for example in a sequence parameter set, a picture parameter set, a slice parameter set, a picture header, a slice header, within a macroblock syntax structure, or anything alike. In some embodiments, it is possible to have more than one pair of indications for the depth/disparity metric and the decoding processes the metric is applied to in a the bitstream having the same persistence for the decoding process, i.e. applicable to decoding of the same access units. The encoder may select which similarity/distortion metric is used for each particular decoding process where a similarity/distortion based selection or other processing is used, such as depth/disparity based intra prediction, and encode respective indications of the selected disparity/distortion metrics and to which decoding processes they apply to into the bitstream.

When the similarity of disparity blocks is compared, the viewpoints of the blocks are typically normalized, e.g. so that the disparity values are scaled to result from the same camera separation in both compared blocks.

There is provided the following elements which can be combined into a single solution, as will be described below, or they can be utilized separately. As explained earlier, both a video encoder and a video decoder typically apply a prediction mechanism, hence the following elements may apply similarly to both a video encoder and a video decoder.

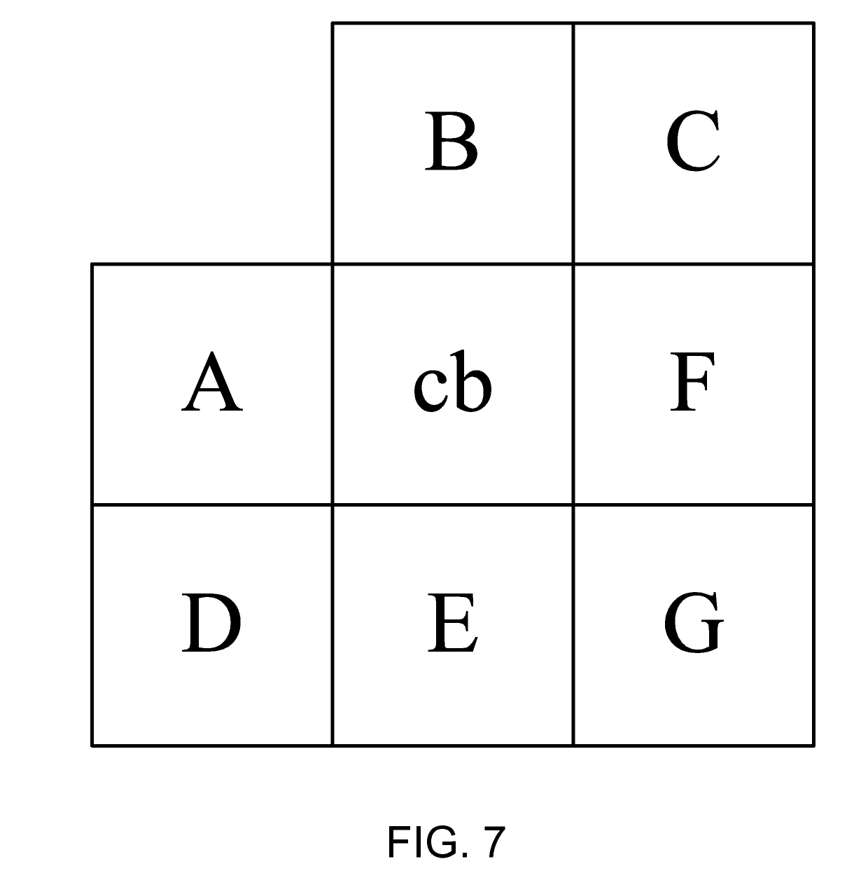

In various embodiments presented above neighboring blocks to the current block being coded/decoded cb are selected. Examples of selecting neighboring blocks include spatial neighbors (e.g. as indicated in FIG. 7). Other examples include disparity-compensated neighbors in adjacent views whereby disparity compensation may be applied to determine correspondence of a neighboring block to cb. The aspects of the invention are not limited to the mentioned methods of selecting neighboring blocks, but rather the description is given for one possible basis on top of which other embodiments of the invention may be partly or fully realized.

In some embodiments, the encoder may determine the value of any of the above-mentioned thresholds for example based on encoding blocks with different values of the threshold and selecting the value of the threshold that is optimal according to the Lagrangian rate-distortion optimization equation. The encoder may indicate the determined value of the threshold within the bitstream, for example by encoding it as a syntax element for example in a sequence parameter set, a picture parameter set, a slice parameter set, a picture header, a slice header, within a macroblock syntax structure, or anything alike. In some embodiments, the decoder determines the threshold based on the information encoded in the bistream, such as a codeword indicating the value of threshold.

In some embodiments, the encoder performs optimization, such as rate-distortion optimization, jointly when selecting values of syntax elements for the current texture block cb and the co-located current depth/disparity block Di(cb). In a joint rate-distortion optimization, the encoder may for example encoder cb and Di(cb) in multiple modes and select the pair of modes that results into the best rate-distortion performance among the tested modes. For example, it may happen that a skip mode would be optimal in rate-distortion performance for Di(cb), but when the rate-distortion performance of cb and Di(cb) is optimized jointly, it may be more beneficial that for example an intra mode is selected for Di(cb) and consequently the block partitioning for Di(cb) becomes encoded and the prediction parameter selection based on Di(cb) may become such that the rate-distortion performance of cb coding is improved. When optimizing the rate and distortion for texture and depth jointly, for example one or more synthesized view may be used to derive the distortion, because texture picture distortion may not be directly comparable to depth picture distortion. The encoder may also select values for syntax elements in such a manner that depth/disparity based prediction parameter becomes effective.

In some embodiments, the encoder may encode some texture views without depth/disparity based prediction parameter derivation while other texture views may be encoded using depth/disparity based prediction parameter derivation. For example, the encoder may encoder the base view of the texture without depth/disparity based prediction parameter derivation and rather use conventional prediction mechanisms. For example, the encoder may encode a bitstream compatible with the H.264/AVC standard by encoding a base view without depth/disparity based prediction parameter derivation and hence the bitstream can be decoded by H.264/AVC decoders. Likewise, the encoder may encode a bitstream where a set of views is compatible with MVC by encoding a base view and the other views in the set of views without depth/disparity based prediction parameter derivation. Consequently, the set of views can be decoded by MVC decoders.

While many of the embodiments are described for intra prediction for luma, it is to be understood that in many coding arrangements chroma intra prediction information may be derived from luma intra prediction information using pre-determined relations. For example, it may be assumed that the same reference samples are used for the chroma components as for luma. In some embodiments, depth pictures have the same spatial resolution as chroma texture pictures, and hence determining co-location as well as correspondence between depth and chroma texture blocks sizes and shapes may be done directly by using depth coordinates and block sizes as chroma texture coordinates and block sizes, respectively, or vice versa. In some embodiments, depth pictures have a different spatial resolution from chroma texture pictures. Therefore, scaling according to the proportion of the spatial resolutions may be taken into account in the determination of co-located or respective blocks in chroma texture and depth view components. Similarly, the size of block partitions may be scaled according to the proportion of the spatial resolutions in the prediction of block partitions from depth to chroma texture.

In some embodiments the spatial resolution of depth/disparity pictures may differ or may be re-sampled in the encoder as a pre-processing operation to become different from that of the luma pictures of texture. In some embodiments, the depth/disparity pictures are re-sampled in the encoding loop and/or the decoding loop to become identical resolution to the respective luma pictures of texture. In other embodiments, the spatially corresponding blocks of depth/disparity pictures are found by scaling the block locations and size proportionally to the ratio of the picture extents of the depth pictures and luma pictures of texture.

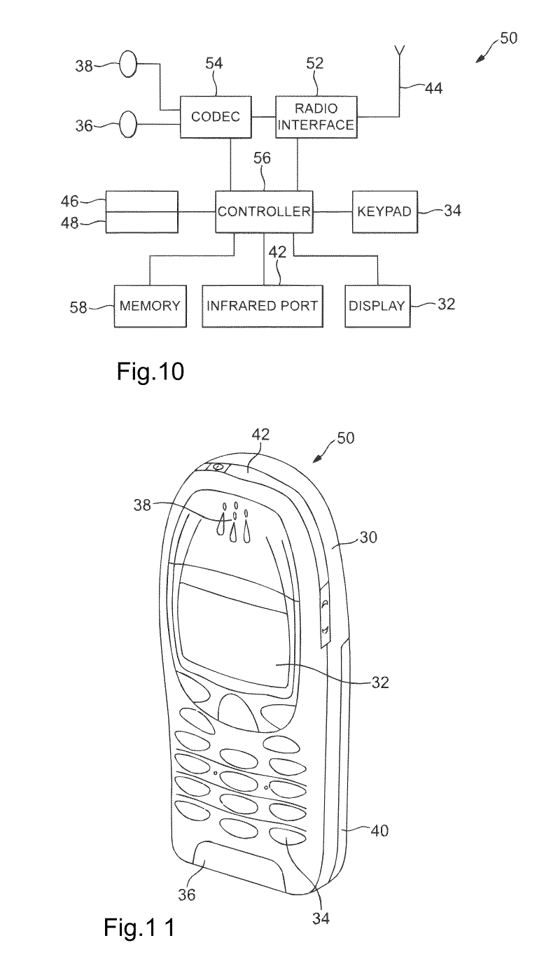

The following describes in further detail suitable apparatus and possible mechanisms for implementing the embodiments of the invention. In this regard reference is first made to FIG. 10 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

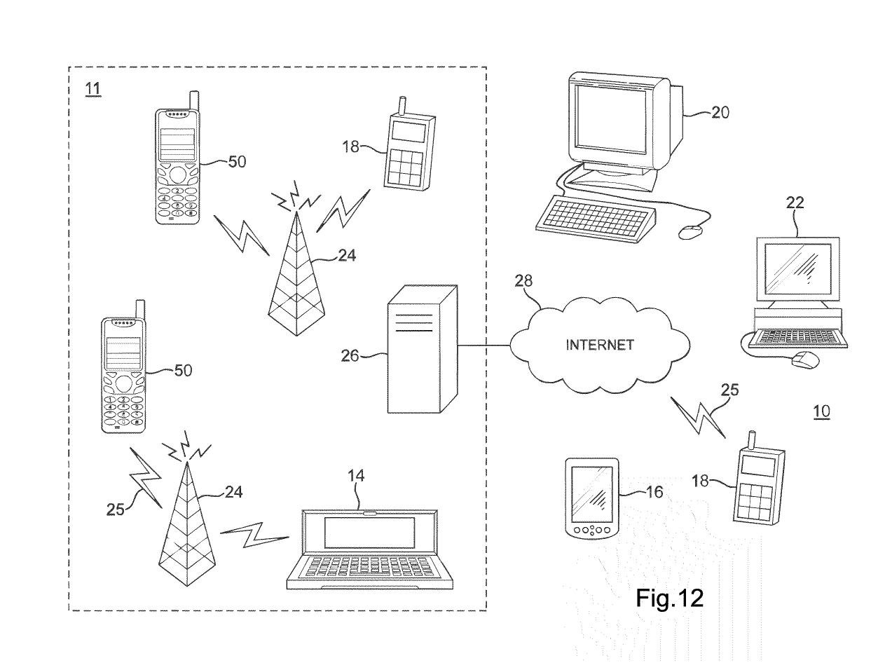

With respect to FIG. 12, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 12 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the interne 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

A method according to a first embodiment comprises:

obtaining depth related information of a part of a picture;

receiving texture related information of the part of the picture;

using the depth related information to determine whether to use the depth related information in intra prediction of the texture related information of the part of the picture.

In some embodiments of the method the texture related information of the part of the picture is a texture block comprising texture pixels and the depth related information of the part of the picture is a depth block comprising depth pixels, and wherein the depth block co-locates with the texture block.

In some embodiments the method comprises using the depth related information to detect whether the depth block comprises a depth boundary.

In some embodiments the part of the picture comprises two or more texture blocks and two or more co-locating depth blocks, wherein the method further comprises coding texture blocks whose co-locating depth blocks do not contain a depth boundary before or after texture blocks whose co-locating depth blocks contain a boundary.

In some embodiments the method comprises marking texture blocks whose co-locating depth block does not contain a depth boundary not available for intra prediction for texture blocks whose co-locating depth blocks comprise a depth boundary or marking texture blocks whose co-locating depth blocks comprise a depth boundary not available for intra prediction for texture blocks whose co-locating depth blocks do not comprise a depth boundary.

In some embodiments the texture block is a macroblock, and the method comprises grouping macroblocks whose co-locating depth blocks do not comprise a depth boundary to one slice group, and grouping macroblocks whose co-locating depth blocks comprise a depth boundary to another slice group.

In some embodiments the method comprises using the depth related information for a texture block partitioning.

In some embodiments a set of texture block partitions comprises co-locating depth blocks having one or more depth boundaries and another set of texture block partitions does not comprise co-locating depth blocks having one or more depth boundaries.

In some embodiments the size of texture block partitions whose co-locating depth pixels do not comprise a depth boundary is made as large as possible among a set of allowed block partitions.

In some embodiments the method comprises using a block partitioning of the depth block as the block partitioning for the respective or co-located texture block.

In some embodiments the method comprises using the depth information to determine an intra-prediction mode.

In some embodiments the method comprises comparing the depth block to a neighboring depth block, and determining the intra prediction mode of the texture block on the basis of the comparison.

In some embodiments the method comprises using the depth related information to determine whether there exist one or more texture pixels available for intra prediction

In some embodiments the method comprises using bi-directional intra prediction for texture blocks whose co-locating depth blocks comprise a depth boundary.

In some embodiments the method comprises using the depth related information to define a weight for intra prediction of the texture block.

In some embodiments the weight is determined on the basis of the difference between the depth of a texture sample being predicted and the depth of a prediction sample.

In some embodiments the depth related information is disparity information.

In some embodiments the part of the picture comprises multiview video information.

An apparatus according to a second embodiment comprises at least one processor and at least one memory including computer program code, the at least one memory and the computer program code configured to, with the at least one processor, cause the apparatus to:

obtain depth related information of a part of a picture;

receive texture related information of the part of the picture;

use the depth related information to determine whether to use the depth related information in intra prediction of the texture related information of the part of the picture.

In some embodiments of the apparatus the texture related information of the part of the picture is a texture block comprising texture pixels and the depth related information of the part of the picture is a depth block comprising depth pixels, and wherein the depth block co-locates with the texture block.

In some embodiments of the apparatus said at least one memory stored with code thereon, which when executed by said at least one processor, further causes the apparatus to use the depth related information to detect whether the depth block comprises a depth boundary.

In some embodiments of the apparatus the part of the picture comprises two or more texture blocks and two or more co-locating depth blocks, said at least one memory stored with code thereon, which when executed by said at least one processor, further causes the apparatus to code texture blocks whose co-locating depth blocks do not contain a depth boundary before or after texture blocks whose co-locating depth blocks contain a boundary.

In some embodiments of the apparatus said at least one memory stored with code thereon, which when executed by said at least one processor, further causes the apparatus to mark texture blocks whose co-locating depth block does not contain a depth boundary not available for intra prediction for texture blocks whose co-locating depth blocks comprise a depth boundary or to mark texture blocks whose co-locating depth blocks comprise a depth boundary not available for intra prediction for texture blocks whose co-locating depth blocks do not comprise a depth boundary.

In some embodiments of the apparatus the texture block is a macroblock, and said at least one memory stored with code thereon, which when executed by said at least one processor, further causes the apparatus to group macroblocks whose co-locating depth blocks do not comprise a depth boundary to one slice group, and to group macroblocks whose co-locating depth blocks comprise a depth boundary to another slice group.

In some embodiments of the apparatus said at least one memory stored with code thereon, which when executed by said at least one processor, further causes the apparatus to use the depth related information for a texture block partitioning.

In some embodiments of the apparatus a set of texture block partitions comprises co-locating depth blocks having one or more depth boundaries and another set of texture block partitions does not comprise co-locating depth blocks having one or more depth boundaries.

In some embodiments of the apparatus said at least one memory stored with code thereon, which when executed by said at least one processor, further causes the apparatus to the size of texture block partitions whose co-locating depth pixels do not comprise a depth boundary as large as possible among a set of allowed block partitions.

In some embodiments of the apparatus said at least one memory stored with code thereon, which when executed by said at least one processor, further causes the apparatus to use a block partitioning of the depth block as the block partitioning for the respective or co-located texture block.

In some embodiments of the apparatus said at least one memory stored with code thereon, which when executed by said at least one processor, further causes the apparatus to use the depth information to determine an intra-prediction mode.

In some embodiments of the apparatus said at least one memory stored with code thereon, which when executed by said at least one processor, further causes the apparatus to compare the depth block to a neighboring depth block, and to determine the intra prediction mode of the texture block on the basis of the comparison.

In some embodiments of the apparatus said at least one memory stored with code thereon, which when executed by said at least one processor, further causes the apparatus to use the depth related information to determine whether there exist one or more texture pixels available for intra prediction.

In some embodiments of the apparatus said at least one memory stored with code thereon, which when executed by said at least one processor, further causes the apparatus to use bi-directional intra prediction for texture blocks whose co-locating depth blocks comprise a depth boundary.

In some embodiments of the apparatus said at least one memory stored with code thereon, which when executed by said at least one processor, further causes the apparatus to use the depth related information to define a weight for intra prediction of the texture block.

In some embodiments of the apparatus said at least one memory stored with code thereon, which when executed by said at least one processor, further causes the apparatus to determine the weight on the basis of the difference between the depth of a texture sample being predicted and the depth of a prediction sample.

In some embodiments of the apparatus the depth related information is disparity information.

In some embodiments of the apparatus the part of the picture comprises multiview video information.

In some embodiments of the apparatus the apparatus is a component of a mobile station.

According to a third embodiment there is provided a computer program product including one or more sequences of one or more instructions which, when executed by one or more processors, cause an apparatus to at least perform the following:

obtain depth related information of a part of a picture;

receive texture related information of the part of the picture;

use the depth related information to determine whether to use the depth related information in intra prediction of the texture related information of the part of the picture.

In some embodiments of the computer program product the texture related information of the part of the picture is a texture block comprising texture pixels and the depth related information of the part of the picture is a depth block comprising depth pixels, and wherein the depth block co-locates with the texture block.

In some embodiments of the computer program product said at least one memory stored with code thereon, which when executed by said at least one processor, further causes the apparatus to use the depth related information to detect whether the depth block comprises a depth boundary.

In some embodiments of the computer program product the part of the picture comprises two or more texture blocks and two or more co-locating depth blocks, said at least one memory stored with code thereon, which when executed by said at least one processor, further causes the apparatus to code texture blocks whose co-locating depth blocks do not contain a depth boundary before or after texture blocks whose co-locating depth blocks contain a boundary.

In some embodiments of the computer program product said at least one memory stored with code thereon, which when executed by said at least one processor, further causes the apparatus to mark texture blocks whose co-locating depth block does not contain a depth boundary not available for intra prediction for texture blocks whose co-locating depth blocks comprise a depth boundary or to mark texture blocks whose co-locating depth blocks comprise a depth boundary not available for intra prediction for texture blocks whose co-locating depth blocks do not comprise a depth boundary.

In some embodiments of the computer program product the texture block is a macroblock, and said at least one memory stored with code thereon, which when executed by said at least one processor, further causes the apparatus to group macroblocks whose co-locating depth blocks do not comprise a depth boundary to one slice group, and to group macroblocks whose co-locating depth blocks comprise a depth boundary to another slice group.

In some embodiments of the computer program product said at least one memory stored with code thereon, which when executed by said at least one processor, further causes the apparatus to use the depth related information for a texture block partitioning.

In some embodiments of the computer program product a set of texture block partitions comprises co-locating depth blocks having one or more depth boundaries and another set of texture block partitions does not comprise co-locating depth blocks having one or more depth boundaries.

In some embodiments of the computer program product said at least one memory stored with code thereon, which when executed by said at least one processor, further causes the apparatus to make the size of texture block partitions whose co-locating depth pixels do not comprise a depth boundary as large as possible among a set of allowed block partitions.

In some embodiments of the computer program product said at least one memory stored with code thereon, which when executed by said at least one processor, further causes the apparatus to use a block partitioning of the depth block as the block partitioning for the respective or co-located texture block.

In some embodiments of the computer program product said at least one memory stored with code thereon, which when executed by said at least one processor, further causes the apparatus to use the depth information to determine an intra-prediction mode.

In some embodiments of the computer program product said at least one memory stored with code thereon, which when executed by said at least one processor, further causes the apparatus to compare the depth block to a neighboring depth block, and to determine the intra prediction mode of the texture block on the basis of the comparison.

In some embodiments of the computer program product said at least one memory stored with code thereon, which when executed by said at least one processor, further causes the apparatus to use the depth related information to determine whether there exist one or more texture pixels available for intra prediction.

In some embodiments of the computer program product said at least one memory stored with code thereon, which when executed by said at least one processor, further causes the apparatus to use bi-directional intra prediction for texture blocks whose co-locating depth blocks comprise a depth boundary.

In some embodiments of the computer program product said at least one memory stored with code thereon, which when executed by said at least one processor, further causes the apparatus to use the depth related information to define a weight for intra prediction of the texture block.

In some embodiments of the computer program product said at least one memory stored with code thereon, which when executed by said at least one processor, further causes the apparatus to determine the weight on the basis of the difference between the depth of a texture sample being predicted and the depth of a prediction sample.

In some embodiments of the computer program product the depth related information is disparity information.

In some embodiments of the computer program product the part of the picture comprises multiview video information.

An apparatus according to a fourth embodiment comprises:

means for obtaining depth related information of a part of a picture;

means for receiving texture related information of the part of the picture;

means for using the depth related information to determine whether to use the depth related information in intra prediction of the texture related information of the part of the picture.

In some embodiments of the apparatus the texture related information of the part of the picture is a texture block comprising texture pixels and the depth related information of the part of the picture is a depth block comprising depth pixels, and wherein the depth block co-locates with the texture block.

In some embodiments the apparatus comprises means for using the depth related information to detect whether the depth block comprises a depth boundary.

In some embodiments of the apparatus the part of the picture comprises two or more texture blocks and two or more co-locating depth blocks, the apparatus further comprising means for coding texture blocks whose co-locating depth blocks do not contain a depth boundary before or after texture blocks whose co-locating depth blocks contain a boundary.

In some embodiments the apparatus comprises means for marking texture blocks whose co-locating depth block does not contain a depth boundary not available for intra prediction for texture blocks whose co-locating depth blocks comprise a depth boundary or marking texture blocks whose co-locating depth blocks comprise a depth boundary not available for intra prediction for texture blocks whose co-locating depth blocks do not comprise a depth boundary.

In some embodiments of the apparatus the texture block is a macroblock, and the apparatus comprises means for grouping macroblocks whose co-locating depth blocks do not comprise a depth boundary to one slice group, and grouping macroblocks whose co-locating depth blocks comprise a depth boundary to another slice group.

In some embodiments the apparatus comprises means for using the depth related information for a texture block partitioning.

In some embodiments of the apparatus a set of texture block partitions comprises co-locating depth blocks having one or more depth boundaries and another set of texture block partitions does not comprise co-locating depth blocks having one or more depth boundaries.

In some embodiments of the apparatus the size of texture block partitions whose co-locating depth pixels do not comprise a depth boundary is made as large as possible among a set of allowed block partitions.

In some embodiments the apparatus comprises means for using a block partitioning of the depth block as the block partitioning for the respective or co-located texture block.

In some embodiments the apparatus comprises means for using the depth information to determine an intra-prediction mode.

In some embodiments the apparatus comprises means for comparing the depth block to a neighboring depth block, and means for determining the intra prediction mode of the texture block on the basis of the comparison.

In some embodiments the apparatus comprises means for using the depth related information to determine whether there exist one or more texture pixels available for intra prediction.

In some embodiments the apparatus comprises means for using bi-directional intra prediction for texture blocks whose co-locating depth blocks comprise a depth boundary.

In some embodiments the apparatus comprises means for using the depth related information to define a weight for intra prediction of the texture block.

In some embodiments the apparatus comprises means for determining the weight on the basis of the difference between the depth of a texture sample being predicted and the depth of a prediction sample.

In some embodiments of the apparatus the depth related information is disparity information.

In some embodiments of the apparatus the part of the picture comprises multiview video information.

According to a fifth embodiment there is provided a method comprising:

receiving encoded depth related information of a part of a picture;

receiving encoded texture related information of the part of the picture;

using the depth related information in decoding the texture related information to determine whether to use the depth related information in intra prediction of the texture related information of the part of the picture.

In some embodiments the encoded texture related information of the part of the picture is a texture block comprising texture pixels and the encoded depth related information of the part of the picture is a depth block comprising depth pixels, and wherein the depth block co-locates with the texture block.

In some embodiments the method comprises using the depth related information to detect whether the depth block comprises a depth boundary.

In some embodiments the part of the picture comprises two or more texture blocks and two or more co-locating depth blocks, the method further comprising decoding texture blocks whose co-locating depth blocks do not contain a depth boundary before or after texture blocks whose co-locating depth blocks contain a boundary.

In some embodiments the texture block is a macroblock, and the method comprises receiving macroblocks whose co-locating depth blocks do not comprise a depth boundary in one slice group, and receiving macroblocks whose co-locating depth blocks comprise a depth boundary to another slice group.

In some embodiments the method comprises using the depth related information for determining a texture block partitioning of the encoded texture information.

In some embodiments a set of texture block partitions comprises co-locating depth blocks having one or more depth boundaries and another set of texture block partitions does not comprise co-locating depth blocks having one or more depth boundaries.

In some embodiments the size of texture block partitions whose co-locating depth pixels do not comprise a depth boundary is made as large as possible among a set of allowed block partitions.

In some embodiments the method comprises using a block partitioning of the depth block as the block partitioning for the respective or co-located texture block.

In some embodiments the method comprises using the depth information to determine an intra-prediction mode.

In some embodiments the method comprises comparing the depth block to a neighboring depth block, and determining the intra prediction mode of the texture block on the basis of the comparison.

In some embodiments the method comprises using the depth related information to determine whether there exist one or more texture pixels available for intra prediction.

In some embodiments the method comprises using bi-directional intra prediction for texture blocks whose co-locating depth blocks comprise a depth boundary.

In some embodiments the method comprises using the depth related information to define a weight for intra prediction of the texture block.

In some embodiments the method comprises determining the weight on the basis of the difference between the depth of a texture sample being predicted and the depth of a prediction sample.

In some embodiments the depth related information is disparity information.

In some embodiments the part of the picture comprises multiview video information.

According to a sixth embodiment there is provided an apparatus comprising at least one processor and at least one memory including computer program code, the at least one memory and the computer program code configured to, with the at least one processor, cause the apparatus to:

receive encoded depth related information of a part of a picture;

receive encoded texture related information of the part of the picture;

use the depth related information in decoding to determine whether to use the depth related information in intra prediction of the texture related information of the part of the picture.

In some embodiments of the apparatus the encoded texture related information of the part of the picture is a texture block comprising texture pixels and the encoded depth related information of the part of the picture is a depth block comprising depth pixels, and wherein the depth block co-locates with the texture block.

In some embodiments of the apparatus said at least one memory stored with code thereon, which when executed by said at least one processor, further causes the apparatus to use the depth related information to detect whether the depth block comprises a depth boundary.

In some embodiments of the apparatus the part of the picture comprises two or more texture blocks and two or more co-locating depth blocks, said at least one memory stored with code thereon, which when executed by said at least one processor, further causes the apparatus to decode texture blocks whose co-locating depth blocks do not contain a depth boundary before or after texture blocks whose co-locating depth blocks contain a boundary.

In some embodiments of the apparatus the texture block is a macroblock, and said at least one memory stored with code thereon, which when executed by said at least one processor, further causes the apparatus to receive macroblocks whose co-locating depth blocks do not comprise a depth boundary to one slice group, and to receive macroblocks whose co-locating depth blocks comprise a depth boundary to another slice group.

In some embodiments of the apparatus said at least one memory stored with code thereon, which when executed by said at least one processor, further causes the apparatus to use the encoded depth related information for a texture block partitioning.

In some embodiments of the apparatus a set of texture block partitions comprises co-locating depth blocks having one or more depth boundaries and another set of texture block partitions does not comprise co-locating depth blocks having one or more depth boundaries.

In some embodiments of the apparatus said at least one memory stored with code thereon, which when executed by said at least one processor, further causes the apparatus to make the size of texture block partitions whose co-locating depth pixels do not comprise a depth boundary as large as possible among a set of allowed block partitions.

In some embodiments of the apparatus said at least one memory stored with code thereon, which when executed by said at least one processor, further causes the apparatus to use a block partitioning of the depth block as the block partitioning for the respective or co-located texture block.

In some embodiments of the apparatus said at least one memory stored with code thereon, which when executed by said at least one processor, further causes the apparatus to use the depth information to determine an intra-prediction mode.

In some embodiments of the apparatus said at least one memory stored with code thereon, which when executed by said at least one processor, further causes the apparatus to compare the depth block to a neighboring depth block, and to determine the intra prediction mode of the texture block on the basis of the comparison.

In some embodiments of the apparatus said at least one memory stored with code thereon, which when executed by said at least one processor, further causes the apparatus to use the depth related information to determine whether there exist one or more texture pixels available for intra prediction.

In some embodiments of the apparatus said at least one memory stored with code thereon, which when executed by said at least one processor, further causes the apparatus to use bi-directional intra prediction for texture blocks whose co-locating depth blocks comprise a depth boundary.

In some embodiments of the apparatus said at least one memory stored with code thereon, which when executed by said at least one processor, further causes the apparatus to use the depth related information to define a weight for intra prediction of the texture block.

In some embodiments of the apparatus said at least one memory stored with code thereon, which when executed by said at least one processor, further causes the apparatus to determine the weight on the basis of the difference between the depth of a texture sample being predicted and the depth of a prediction sample.

In some embodiments of the apparatus the depth related information is disparity information.

In some embodiments of the apparatus the part of the picture comprises multiview video information.

In some embodiments the apparatus is a component of a mobile station.

An apparatus according to a seventh embodiment comprises computer program product including one or more sequences of one or more instructions which, when executed by one or more processors, cause an apparatus to at least perform the following:

receive encoded depth related information of a part of a picture;

receive encoded texture related information of the part of the picture;

use the depth related information in decoding to determine whether to use the depth related information in intra prediction of the texture related information of the part of the picture.

In some embodiments of the apparatus the encoded texture related information of the part of the picture is a texture block comprising texture pixels and the encoded depth related information of the part of the picture is a depth block comprising depth pixels, and wherein the depth block co-locates with the texture block.

In some embodiments of the apparatus said at least one memory stored with code thereon, which when executed by said at least one processor, further causes the apparatus to use the depth related information to detect whether the depth block comprises a depth boundary.

In some embodiments of the apparatus the part of the picture comprises two or more texture blocks and two or more co-locating depth blocks, said at least one memory stored with code thereon, which when executed by said at least one processor, further causes the apparatus to decode texture blocks whose co-locating depth blocks do not contain a depth boundary before or after texture blocks whose co-locating depth blocks contain a boundary.

In some embodiments of the apparatus the texture block is a macroblock, and said at least one memory stored with code thereon, which when executed by said at least one processor, further causes the apparatus to receive macroblocks whose co-locating depth blocks do not comprise a depth boundary to one slice group, and to receive macroblocks whose co-locating depth blocks comprise a depth boundary to another slice group.

In some embodiments of the apparatus said at least one memory stored with code thereon, which when executed by said at least one processor, further causes the apparatus to use the encoded depth related information for a texture block partitioning.

In some embodiments of the apparatus a set of texture block partitions comprises co-locating depth blocks having one or more depth boundaries and another set of texture block partitions does not comprise co-locating depth blocks having one or more depth boundaries.

In some embodiments of the apparatus said at least one memory stored with code thereon, which when executed by said at least one processor, further causes the apparatus to make the size of texture block partitions whose co-locating depth pixels do not comprise a depth boundary as large as possible among a set of allowed block partitions.

In some embodiments of the apparatus said at least one memory stored with code thereon, which when executed by said at least one processor, further causes the apparatus to use a block partitioning of the depth block as the block partitioning for the respective or co-located texture block.

In some embodiments of the apparatus said at least one memory stored with code thereon, which when executed by said at least one processor, further causes the apparatus to use the depth information to determine an intra-prediction mode.

In some embodiments of the apparatus said at least one memory stored with code thereon, which when executed by said at least one processor, further causes the apparatus to compare the depth block to a neighboring depth block, and to determine the intra prediction mode of the texture block on the basis of the comparison.

In some embodiments of the apparatus said at least one memory stored with code thereon, which when executed by said at least one processor, further causes the apparatus to use the depth related information to determine whether there exist one or more texture pixels available for intra prediction.

In some embodiments of the apparatus said at least one memory stored with code thereon, which when executed by said at least one processor, further causes the apparatus to use bi-directional intra prediction for texture blocks whose co-locating depth blocks comprise a depth boundary.

In some embodiments of the apparatus said at least one memory stored with code thereon, which when executed by said at least one processor, further causes the apparatus to use the depth related information to define a weight for intra prediction of the texture block.

In some embodiments of the apparatus said at least one memory stored with code thereon, which when executed by said at least one processor, further causes the apparatus to determine the weight on the basis of the difference between the depth of a texture sample being predicted and the depth of a prediction sample.

In some embodiments of the apparatus the depth related information is disparity information.

In some embodiments of the apparatus the part of the picture comprises multiview video information.

An apparatus according to an eighth embodiment comprises:

means for receiving encoded depth related information of a part of a picture;

means for receiving encoded texture related information of the part of the picture;

means for using the depth related information in decoding to determine whether to use the depth related information in intra prediction of the texture related information of the part of the picture.

In some embodiments of the apparatus the encoded texture related information of the part of the picture is a texture block comprising texture pixels and the encoded depth related information of the part of the picture is a depth block comprising depth pixels, and wherein the depth block co-locates with the texture block.

In some embodiments the apparatus comprises means for using the depth related information to detect whether the depth block comprises a depth boundary.

In some embodiments of the apparatus the part of the picture comprises two or more texture blocks and two or more co-locating depth blocks, the apparatus further comprising means for decoding texture blocks whose co-locating depth blocks do not contain a depth boundary before or after texture blocks whose co-locating depth blocks contain a boundary.

In some embodiments of the apparatus the texture block is a macroblock, and the apparatus comprises means for receiving macroblocks whose co-locating depth blocks do not comprise a depth boundary to one slice group, and receiving macroblocks whose co-locating depth blocks comprise a depth boundary to another slice group.

In some embodiments the apparatus comprises means for using the encoded depth related information for a texture block partitioning.

In some embodiments of the apparatus a set of texture block partitions comprises co-locating depth blocks having one or more depth boundaries and another set of texture block partitions does not comprise co-locating depth blocks having one or more depth boundaries.

In some embodiments of the apparatus the size of texture block partitions whose co-locating depth pixels do not comprise a depth boundary is made as large as possible among a set of allowed block partitions.

In some embodiments the apparatus comprises means for using a block partitioning of the depth block as the block partitioning for the respective or co-located texture block.

In some embodiments the apparatus comprises means for using the depth information to determine an intra-prediction mode.

In some embodiments the apparatus comprises means for comparing the depth block to a neighboring depth block, and means for determining the intra prediction mode of the texture block on the basis of the comparison.

In some embodiments the apparatus comprises means for using the depth related information to determine whether there exist one or more texture pixels available for intra prediction.

In some embodiments the apparatus comprises means for using bi-directional intra prediction for texture blocks whose co-locating depth blocks comprise a depth boundary.

In some embodiments the apparatus comprises means for using the depth related information to define a weight for intra prediction of the texture block.

In some embodiments the apparatus comprises means for determining the weight on the basis of the difference between the depth of a texture sample being predicted and the depth of a prediction sample.

In some embodiments of the apparatus the depth related information is disparity information.

In some embodiments of the apparatus the part of the picture comprises multiview video information.

A video coder according to a ninth embodiment is configured for:

obtaining depth related information of a part of a picture;

receiving texture related information of the part of the picture;

using the depth related information to determine whether to use the depth related information in intra prediction of the texture related information of the part of the picture.

A video decoder according to a tenth embodiment is configured for:

receiving encoded depth related information of a part of a picture;

receiving encoded texture related information of the part of the picture;

using the depth related information in decoding the texture related information to determine whether to use the depth related information in intra prediction of the texture related information of the part of the picture.

1. A method comprising:
obtaining depth related information of a part of a picture;
receiving texture related information of the part of the picture; and
using the depth related information to determine whether to use the depth related information in intra prediction of the texture related information of the part of the picture.

2. The method according to claim 1 wherein the texture related information of the part of the picture is a texture block comprising texture pixels and the depth related information of the part of the picture is a depth block comprising depth pixels, and wherein the depth block co-locates with the texture block

3. The method according to claim 2, wherein the part of the picture comprises two or more texture blocks and two or more co-locating depth blocks, the method further comprising coding texture blocks whose co-locating depth blocks do not contain a depth boundary before or after texture blocks whose co-locating depth blocks contain a boundary.

4. The method according to claim 2 comprising marking texture blocks whose co-locating depth block does not contain a depth boundary not available for intra prediction for texture blocks whose co-locating depth blocks comprise a depth boundary or marking texture blocks whose co-locating depth blocks comprise a depth boundary not available for intra prediction for texture blocks whose co-locating depth blocks do not comprise a depth boundary.

5. The method according to claim 2 comprising using the depth related information for a texture block partitioning.

6. The method according to claim 2, wherein the size of texture block partitions whose co-locating depth pixels do not comprise a depth boundary is made as large as possible among a set of allowed block partitions.

7. The method according to claim 6 comprising using a block partitioning of the depth block as the block partitioning for the respective or co-located texture block.

8. The method according to claim 1 comprising comparing the depth block to a neighboring depth block, and determining an intra prediction mode of the texture block on the basis of the comparison.

9. The method according to claim 1 comprising using the depth related information to determine whether there exist one or more texture pixels available for intra prediction.

10. An apparatus comprising at least one processor and at least one memory including computer program code, the at least one memory and the computer program code configured to, with the at least one processor, cause the apparatus to:
obtain depth related information of a part of a picture;
receive texture related information of the part of the picture; and
use the depth related information to determine whether to use the depth related information in intra prediction of the texture related information of the part of the picture.

11. The apparatus according to claim 10 wherein the texture related information of the part of the picture is a texture block comprising texture pixels and the depth related information of the part of the picture is a depth block comprising depth pixels, and wherein the depth block co-locates with the texture block, wherein said at least one memory stored with code thereon, which when executed by said at least one processor, further causes the apparatus to use the depth related information to detect whether the depth block comprises a depth boundary.

12. The apparatus according to claim 11, wherein the part of the picture comprises two or more texture blocks and two or more co-locating depth blocks, said at least one memory stored with code thereon, which when executed by said at least one processor, further causes the apparatus to code texture blocks whose co-locating depth blocks do not contain a depth boundary before or after texture blocks whose co-locating depth blocks contain a boundary.

13. A computer program product including one or more sequences of one or more instructions which, when executed by one or more processors, cause an apparatus to at least perform the following:
obtain depth related information of a part of a picture;
receive texture related information of the part of the picture; and
use the depth related information to determine whether to use the depth related information in intra prediction of the texture related information of the part of the picture.

14. An apparatus comprising:
means for obtaining depth related information of a part of a picture;
means for receiving texture related information of the part of the picture; and
means for using the depth related information to determine whether to use the depth related information in intra prediction of the texture related information of the part of the picture.

15. A method comprising:
receiving encoded depth related information of a part of a picture;
receiving encoded texture related information of the part of the picture; and
using the depth related information in decoding the texture related information to determine whether to use the depth related information in intra prediction of the texture related information of the part of the picture.

16. The method according to claim 15 wherein the encoded texture related information of the part of the picture is a texture block comprising texture pixels and the encoded depth related information of the part of the picture is a depth block comprising depth pixels, and wherein the depth block co-locates with the texture block.

17. The method according to claim 16 comprising using the depth related information for determining a texture block partitioning of the encoded texture information.

18. An apparatus comprising at least one processor and at least one memory including computer program code, the at least one memory and the computer program code configured to, with the at least one processor, cause the apparatus to:
receive encoded depth related information of a part of a picture;
receive encoded texture related information of the part of the picture; and
use the depth related information in decoding to determine whether to use the depth related information in intra prediction of the texture related information of the part of the picture.

19. A computer program product including one or more sequences of one or more instructions which, when executed by one or more processors, cause an apparatus to at least perform the following:
receive encoded depth related information of a part of a picture;
receive encoded texture related information of the part of the picture; and
use the depth related information in decoding to determine whether to use the depth related information in intra prediction of the texture related information of the part of the picture.

20. An apparatus comprising:
means for receiving encoded depth related information of a part of a picture;
means for receiving encoded texture related information of the part of the picture; and
means for using the depth related information in decoding to determine whether to use the depth related information in intra prediction of the texture related information of the part of the picture.
